(19) United States
(12) Patent Application Publication
(10) Pub. No.: US 2018/0102027 A1
(43) Pub. Date: Apr. 12, 2018

(54) GAMING SYSTEM, DEVICE AND METHOD INVOLVING A PRIMARY OUTCOME GENERATOR AND A DRAW-BASED SECONDARY OUTCOME GENERATOR

(71) Applicant: iLight Empreendimentos e Participacoes Ltda. - ME, Sao Paulo (BR)

(72) Inventors: Eduardo P. Paiva, Sao Paulo (BR); Arba J. McCullough, JR., Tulsa, OK (US)

(73) Assignee: iLight Empreendimentos e Participacoes Ltda. - ME, Sao Paulo (BR)

(21) Appl. No.: 15/290,395

(22) Filed: Oct. 11, 2016

(51) Int. Cl. G07F 17/32; G07C 15/00

(52) U.S. Cl. CPC G07F 17/3267; G07F 17/3293; G07F 17/329; G07F 17/3258; G07C 15/006; G07F 17/3269; G07F 17/3241; G07F 17/3223; G07F 17/3276

(57) ABSTRACT

A gaming system, device and method include, in an embodiment, computer-readable instructions executable to operate primary and secondary games. The instructions are executable to receive a plurality of wager inputs from a plurality of devices operated by a plurality of players, and the instructions are executable to control the primary and secondary games for the players. The secondary game's outcomes include results of a plurality of selections from a finite pool of outcomes. The instructions are further executable to cause each one of the devices to indicate a payout depending on the outcomes of the primary and secondary games.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

Certain laws regulate the types of wager-based gaming that can occur in various territories, including the United States and other countries. In the United States, for example, the Indian Gaming Regulatory Act (25 U.S.C.S. § 2701 et seq.), as amended (“IGRA”) applies to Native American gaming which takes place on Native American reservations and within the territories of Native American Tribes. The IGRA categorizes classes I, II and III for wager-based games. Class I games relates to traditional Indian gaming which may be part of tribal ceremonies and celebrations, and class I also relates to social games for minimal prizes. Class II relates to games of chance commonly known as bingo, and class II can also include pull tabs, lotto, scratch-off tickets, punch boards, tip jars, instant bingo, other games similar to bingo, and various card games. Class III relates to wager-based games that are outside of classes I and II, including games commonly played at casinos, such as slot machines, blackjack, craps and roulette.

The IGRA grants Tribes exclusive authority to operate class I and II games, but the IGRA restricts the authority of Tribes to operate class III games. For example, for a Tribe to operate a class III game in a State, the State must permit the particular type of game, the Tribe must pay a fee, and the Tribe is required to obtain additional governmental approvals. Also, each Tribe is limited to a certain number of approvals for class III games.

Because of these restrictions, Tribes can more readily offer class II games than class III games. A disadvantage, however, is that class II games can lack the excitement and entertainment of class III games. To address this disadvantage, some companies have developed class II video terminals which discretely run class II bingo games while prominently displaying slot reel graphics to the players. Such slot reel graphics are designed to resemble the bingo pattern outcomes in an attempt to create a class III slot game experience.

However, these class II terminals have several shortcomings. For example, the terminals lack variety in the types of game themes available to players. Also, these terminals lack in wagering and winning opportunities available throughout the game play session. Furthermore, with these class II terminals, the player can recognize that the reel symbol patterns mirror the bingo patterns, detracting from the intended slot game experience. For the foregoing reasons, players can lose interest in playing these terminals, players can lack entertainment value from these terminals, and gaming facilities can experience difficulty in generating sufficient revenue from the these terminals.

The foregoing background describes some, but not necessarily all, of the problems, disadvantages and shortcomings related to the known class II games and terminals.

### SUMMARY

In an embodiment, the gaming system includes a data storage device storing a plurality of computer-readable instructions which are executable by at least one processor to: (a) receive a plurality of wager inputs from a plurality of devices, wherein the wager inputs correspond to a plurality of wagers from a plurality of players; and (b) start a game session beginning with play of a primary game by a plurality of the players and continuing through each player's play of a secondary game.

In relation to the primary game, the instructions are executable by the processor to: (a) cause each one of the devices to display a primary interface which graphically represents the primary game; and (b) determine a primary game outcome for each one of the players, wherein the primary game outcomes are selected from a common primary outcome pool. In relation to each one of the secondary games, the instructions are executable by the processor to determine a secondary game outcome for each one of the players according to a secondary outcome generating process, wherein: (i) the secondary game outcomes are determined independent of the primary game outcomes; (ii) the secondary game outcomes are selected from a common secondary outcome pool; and (iii) the secondary game outcomes are eliminated from the common secondary outcome pool as the secondary game outcomes are selected. As described further below, in an embodiment, the secondary game is a consolation game including a secondary outcome (e.g., a consolation award) not generated in the primary game.

The instructions are also executable by the processor to: (a) receive a plurality of preference inputs from the devices, wherein each one of the preference inputs corresponds to one of the player's selection of a secondary interface from a group of secondary interfaces, wherein the secondary interfaces graphically represent different game types for the secondary game; (b) cause each one of the devices to operate the secondary game, wherein the operation comprises displaying one of the selected secondary interfaces and indicating one of the secondary game outcomes; (c) cause each one of the devices to indicate one of the primary game outcomes before, after or when the secondary game outcome is indicated by the device; and (d) depending upon the primary and secondary game outcomes, cause each one of the devices to provide at least one payout based on one of the wagers.

In another embodiment, the gaming system includes a data storage device storing a plurality of computer-readable instructions which are executable by at least one processor to: (a) receive a plurality of wager inputs corresponding to a plurality of wagers from a plurality of players; (b) operate a primary outcome generator corresponding to a primary game comprising a primary interface, wherein the operation of the primary outcome generator results in a plurality of primary outcomes for the plurality of players; and (c) operate a supplemental outcome generator associated with a supplemental game, wherein: (i) the operation of the supplemental outcome generator comprises a plurality of outcome selection steps; (ii) each one of the outcome selection steps results in a supplemental outcome selected from a finite pool of supplemental outcomes; and (iii) each one of the supplemental outcomes selected in one of the selection steps is unavailable for all subsequent outcome selection steps.

The instructions are also executable by the processor to access data corresponding to a plurality of supplemental interfaces including: (a) a first supplemental interface representing a first type of supplemental game; and (b) a second supplemental interface representing a second type of supplemental game. As described further below, in an embodiment, the supplemental game is a consolation game including a supplemental outcome (e.g., a consolation award) not generated in the primary game.

In relation to each one of the players, the instructions are executable by the processor to receive a preference input corresponding to the player's selection of one of the first and second supplemental interfaces. If the first supplemental interface is selected, the instructions are executable by the processor to cause the first supplemental interface to indicate at least one of the supplemental outcomes selected from the finite pool. If the second supplemental interface is selected, the instructions are executable by the processor to cause the second supplemental interface to indicate at least one of the supplemental outcomes selected from the finite pool. The instructions are also executable by the processor to indicate the at least one primary outcome before or after the indication of the at least one supplemental outcome.

Yet another embodiment includes a method for operating primary and secondary games, wherein the primary and secondary games qualify for a class II game type according to United States law. The method includes: (a) receiving a plurality of wager inputs from a plurality of devices operated by a plurality of players; (b) controlling the primary game for the players, resulting in a game-ending primary game outcome; (c) controlling the secondary game for the players, resulting in a plurality of secondary game outcomes, wherein: (i) the secondary game outcomes include results of a plurality of selections from a finite pool of outcomes; and (ii) the secondary game outcomes in the finite pool are selectable no more than once; and (d) causing each one of the devices to indicate a payout depending on the game-ending primary game outcome and at least one of the secondary game outcomes. As described further below, in an embodiment of this method, the secondary game is a consolation game including a secondary outcome (e.g., a consolation award) not generated in the primary game. Also, in an embodiment, such United States law includes the IGRA as regulated by the National Indian Gaming Commission (“NIGC”) and United States Department of the Interior.

Still another embodiment includes a gaming device, including, but not limited to, a class II terminal, Video Lottery Terminal, gaming machine, electronic wagering table or other gaming apparatus. The gaming device includes: (a) a housing; (b) a device processor positioned within the housing; (c) a payment acceptor operatively coupled to the device processor; (d) payout device operatively coupled to the device processor; and (e) a display device operatively coupled to the device processor. The device processor is configured to communicate with at least one processor positioned within a data storage device located physically apart from the gaming device.

The data storage device stores a plurality of computer-readable instructions which are executable by the at least one processor to: (a) receive a plurality of wager inputs from the device processor and at least one additional device processor of an additional gaming device, wherein the wager inputs correspond to a plurality of wagers from a plurality of players; (b) start a game session beginning with play of a primary game by a plurality of the players and continuing through each player's play of a secondary game; (c) in relation to the primary game: (i) cause the gaming device and the additional gaming device to each display a primary interface which graphically represents the primary game; and (ii) determine a primary game outcome for each one of the players, wherein the primary game outcomes are selected from a common primary outcome pool; (d) in relation to each one of the secondary games, determine a secondary game outcome for each one of the players according to a secondary outcome generating process, wherein: (i) the secondary game outcomes are determined independent of the primary game outcomes; (ii) the secondary game outcomes are selected from a common secondary outcome pool; and (iii) the secondary game outcomes are eliminated from the common secondary outcome pool as the secondary game outcomes are selected; (e) receive a plurality of preference inputs from the gaming device and the additional gaming device, wherein each one of the preference inputs corresponds to one of the player's selection of a secondary interface from a group of secondary interfaces, wherein the secondary interfaces graphically represent different game types for the secondary game; (f) cause the gaming device and the additional gaming device to each operate the secondary game, wherein the operation includes displaying one of the selected secondary interfaces and indicating one of the secondary game outcomes; (g) cause the gaming device and the additional gaming device to each indicate one of the primary game outcomes before, after or when the secondary game outcome is indicated; and (h) depending upon the primary and secondary game outcomes, cause the payout device and the additional gaming device to each provide at least one payout based on one of the wagers. As described further below, in an embodiment, the secondary game is a consolation game including a secondary outcome (e.g., a consolation award) not generated in the primary game.

Additional features and advantages of the present disclosure are described in, and will be apparent from, the following Brief Description of the Drawings and Detailed Description.

### BRIEF DESCRIPTION OF THE DRAWINGS

FIG. 1 is a schematic block diagram of an embodiment of the gaming system and central determination architecture.

FIG. 2 is a schematic block diagram of an embodiment of the common primary outcome generator and common draw-based secondary outcome generator, illustrating data flow to primary and secondary games.

FIG. 3 is a schematic diagram of an embodiment of a finite outcome pool, illustrating the pool's conditions before and after a number drawing.

FIG. 4 is a schematic flow diagram of an embodiment of a draw-based outcome generation in comparison to an embodiment of an RNG outcome generation.

FIG. 5 is a schematic block diagram of an embodiment of an electronic hardware configuration of an embodiment of a device operable with the gaming system of FIG. 1.

FIG. 6 is a schematic diagram of an example of a plurality of types of devices operable with the gaming system of FIG. 1.

FIG. 7 is top view of an embodiment of an interface structure for the screen of a device controlled by the gaming system of FIG. 1.

FIG. 8 is a table illustrating a first example of a primary game outcome table.

FIG. 9 is a table illustrating a second example of a primary game outcome table.

FIG. 10 is a table illustrating examples of a plurality of interchangeable secondary interfaces displayable by devices controlled by the gaming system of FIG. 1.

FIG. 11 is a table illustrating an example of a secondary game outcome table.

FIG. 12 is a top view of an embodiment of a main interface displayable by devices controlled by the gaming system of FIG. 1, illustrating an example of a slot interface within an active secondary window.

FIG. 13 is a top view of another embodiment of a main interface displayable by devices controlled by the gaming system of FIG. 1, illustrating an example of a slot interface within an active secondary window.

FIG. 14 is a table illustrating an example of a secondary game paytable.

FIG. 15 is a top view of an embodiment of a main interface displayable by devices controlled by the gaming system of FIG. 1, illustrating an example of a bonus interface within an active secondary window.

FIG. 16 is a top view of an embodiment of a main interface displayable by devices controlled by the gaming system of FIG. 1, illustrating another example of a bonus interface within an active secondary window.

FIG. 17 is a top view of an embodiment of a main interface displayable by devices controlled by the gaming system of FIG. 1, illustrating a pre-start condition of a Latin bingo interface within an active secondary window.

FIG. 18 is a top view of the embodiment of the main interface of FIG. 17, illustrating a post-start condition of a Latin bingo interface within an active secondary window.

FIG. 19 is a schematic diagram illustrating an embodiment of a common draw-based secondary outcome generator having a shuffler.

### DETAILED DESCRIPTION

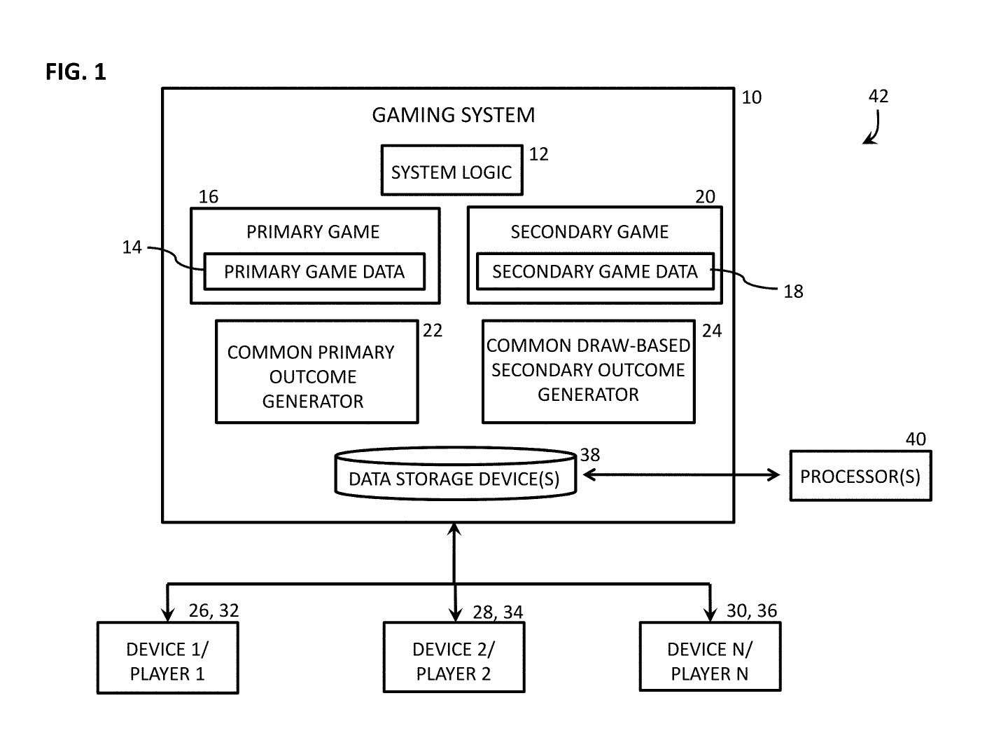

Referring to FIG. 1, the gaming system 10, in an embodiment, includes system logic 12, primary game data 14 associated with a primary game 16, secondary game data 18 associated with a secondary game 20 (including, but not limited to, a consolation game), a common primary outcome generator 22 and a common draw-based secondary outcome generator 24. The gaming system 10 is configured to be operatively coupled to a plurality of devices 26, 28 and 30 operable at the same time by different players 32, 34 and 36, respectively. In an embodiment, the gaming system 10 includes at least one data storage device 38 which stores the system logic 12, primary game data 14, secondary game data 18, common primary outcome generator 22 and common draw-based secondary outcome generator 24. The data storage device 38 is configured to be operatively coupled to at least one processor 40. The processor 40 performs a plurality of steps and functions according to the instructions and logic of the gaming system 10. For purposes of this disclosure, descriptions of the gaming system 10 as a performer of functions means that the processor 40 performs such functions according to the gaming system 10.

In an embodiment, the processor 40 and devices 26, 28, 30 are operatively coupled to a data network, such as a local area network (LAN), wide area network (WAN), cellular network or the Internet. Depending upon the embodiment, the data network can be wire-based or wireless. The gaming system 10 operates or controls the devices 26, 28, 30 based on a central determination architecture 42. In an embodiment, the players 32, 34, 36 simultaneously play games through community-style betting in which the game outcomes are based on a centralized or common outcome pool shared among all of the players 32, 34, 36. In such embodiment, each of the devices 26, 28, 30 has an equal chance of winning a prize or payout.

In an embodiment, the system logic 12 includes computer programs, mathematical formulas, algorithms, computer code and machine or computer-readable instructions, together with associated data sets, tables and data file libraries. The system logic 12 provides the protocols and procedures for controlling the overall operation of the primary and secondary games 16, 20, the primary and secondary outcome generators 22, 24 and the devices 26, 28, 30. The primary game data 14 includes the data files and data sets associated with the primary game 16, including, but not limited to, images, primary game graphical user interfaces (GUIs), audio or sound files, primary game outcome tables (e.g., primary game outcome tables 44, 46 described below) and primary game paytables. The secondary game data 18 includes the data files and data sets associated with the secondary game 20, including, but not limited to, images, secondary game GUIs, audio or sound files, secondary game outcome tables (e.g., secondary game outcome table 48 described below) and secondary game paytables (e.g., secondary game paytable 50 described below).

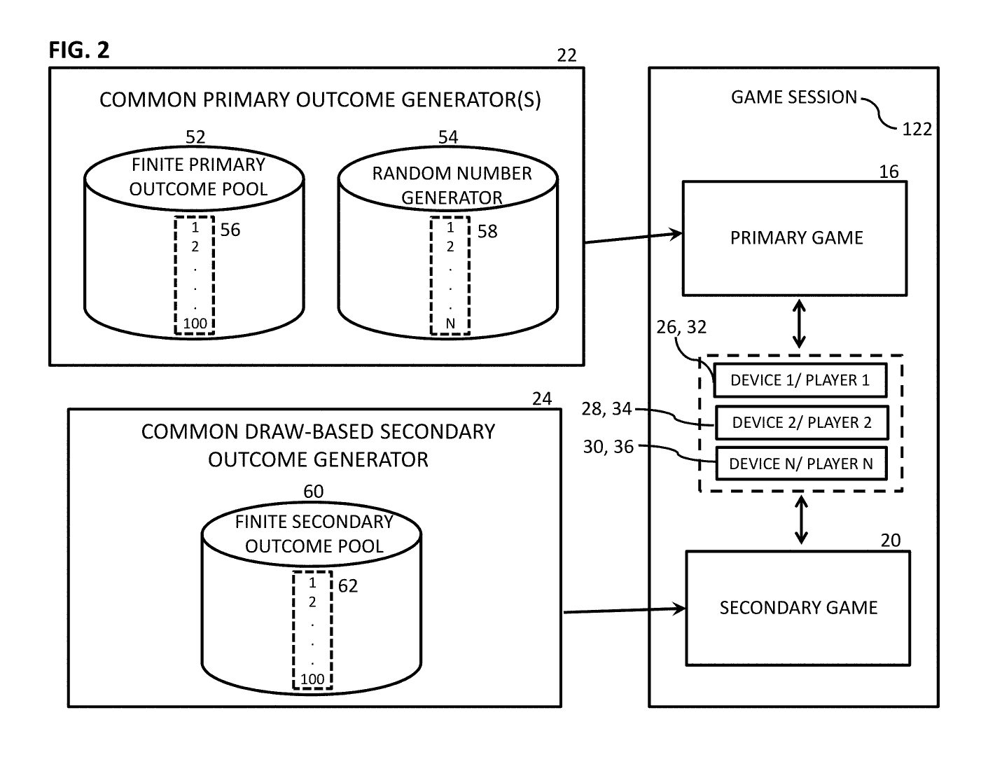

As illustrated in FIG. 2, in an embodiment, the common primary outcome generator 22 includes a finite primary outcome pool 52 and a random number generator (RNG) 54. It should be appreciated that the common primary outcome generator 22 can include only the finite primary outcome pool 52, only the RNG 54 or both the finite primary outcome pool 52 and the RNG 54. The finite primary outcome pool 52 includes one or more databases or data tables having a finite number set 56, such as numbers one through one hundred. The gaming system 10 is operable to: (i) withdraw or draw numbers from the finite number set 56 as described below; and (ii) output the drawn numbers for the function of the primary game 16. The RNG 54 includes one or more computer programs, mathematical formulas or algorithms operable to: (a) randomly or pseudo-randomly generate numbers; and (b) output the generated numbers for the function of the primary game 16. In an embodiment, the RNG 54 includes one or more seeds, such as seed 58. Seed 58 includes a set of numbers one through N, and the logic of the RNG 54 randomly or pseudo-randomly points to one of the numbers in the seed 58. This is one of the numbers generated and output by the RNG 54.

Also, as illustrated in FIG. 2, the common draw-based secondary outcome generator 24 has a finite secondary outcome pool 60. The finite secondary outcome pool 60 includes one or more databases or data tables having a finite number set 62, such as numbers one through one hundred. The gaming system 10 is operable to: (i) withdraw or draw numbers from the finite number set 60 as described below; and (ii) output the drawn numbers for the function of the secondary game 20.

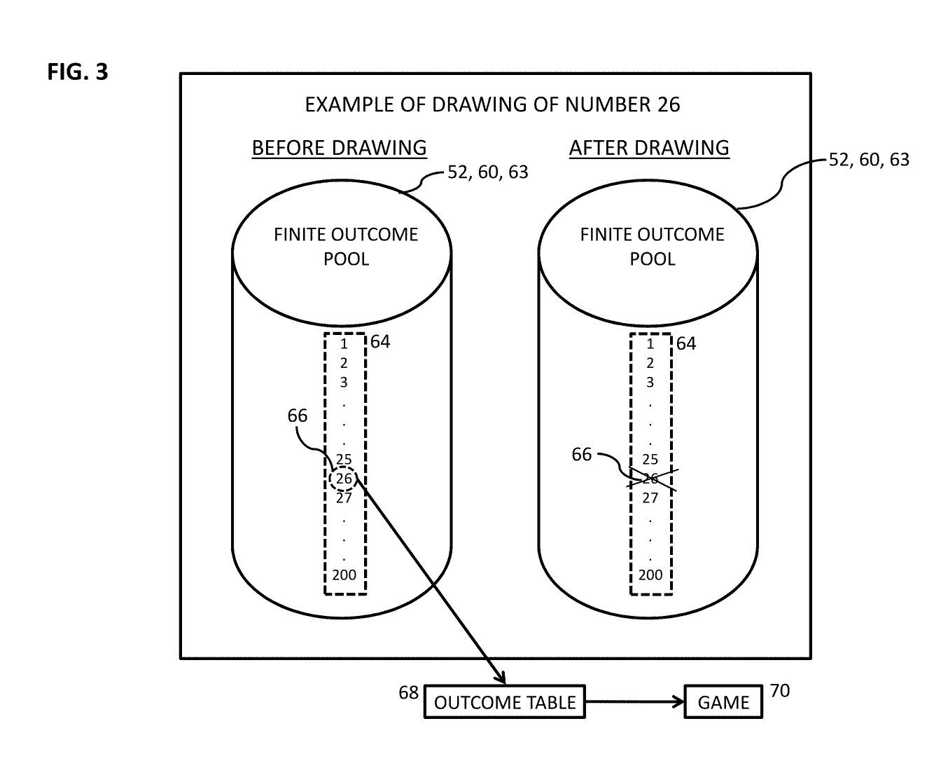

In the example illustrated in FIG. 3, the finite outcome pool 63 (e.g., finite primary outcome pool 52 or finite secondary outcome pool 60) is populated with a finite number set 64 of numbers one through two hundred. In operation, the gaming system 10 performs a first step of withdrawing or drawing number 66 (number twenty-six, in this example) from the finite number set 64. In this first step, the gaming system 10 outputs the drawn number 66 and processes the drawn number 66 with reference to an outcome table 68. Based on the outcome table 68, the gaming system 10 provides an outcome to a game 70. The game 70 is the primary game 16 if the finite outcome pool 63 is the finite primary outcome pool 52, and the game 70 is the secondary game 20 if the finite outcome pool 63 is the finite secondary outcome pool 60.

Also, in this first step, the gaming system 10 disables, eliminates or removes the drawn number 66 from the finite outcome pool 63 and finite number set 64. As illustrated, before the drawing, the finite outcome pool 63 includes number 66, and after the drawing, the finite outcome pool 63 excludes number 66 as indicated by the X marked over the number 66. It should be appreciated that the gaming system 10 can eliminate or remove a drawn number from the finite outcome pool 63 by adding a flag data point associated with such number or by otherwise programmatically designating such drawn number as eliminated or unavailable until a new game session 122 starts.

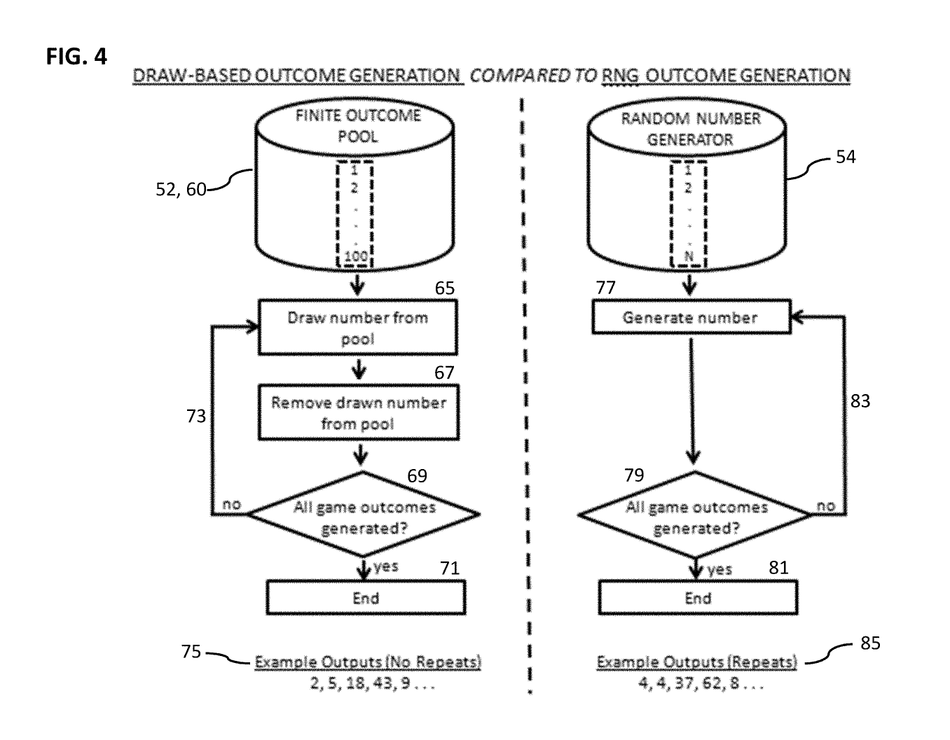

As illustrated in FIG. 4, there is a significant and important difference between generating outcomes based on draws from a finite outcome pool 52, 60 and generating outcomes based on RNG 54. When using a finite outcome pool 52, 60, the gaming system 10 draws a number from the pool 52, 60 as indicated by block 65. Next, the gaming system 10 removes the drawn number from the pool 52, 60 or otherwise disables the drawn number, as indicated by block 67. Next, the gaming system 10 determines whether all of the game outcomes have been generated, as indicated by diamond 69. If so, the gaming system 10 ends the number drawing process, as indicated by block 71. If not, the gaming system 10 repeats the drawing loop, as indicated by arrow 73. As demonstrated by example 75 in FIG. 4, the process in this embodiment produces unique number draws with no possibility of generated repeated or identical numbers.

When using the RNG 54, the gaming system 10 generates a number, as indicated by block 77. Note that, in this embodiment, the gaming system 10 does not remove the generated number from the RNG 54. Next, the gaming system 10 determines whether all of the game outcomes have been generated, as indicated by diamond 79. If so, the gaming system 10 ends the number generation process, as indicated by block 81. If not, the gaming system 10 repeats the generation loop, as indicated by arrow 83. As demonstrated by example 85 in FIG. 4, the process in this embodiment produces numbers with the possibility of generating repeated or identical numbers, such as the generation of two instances of the number four, as shown in example 85.

Referring back to FIG. 1, the data storage device 38 can include a database, server, memory device or other data storage medium accessible by the processor 40. In one example, the devices 26, 28, 30 are physically located at a brick-and-mortar gaming facility, and the data storage device 38 is a server in control of such devices 26, 28, 30. Such server can be located onsite at such facility, or such server can be located remote from such facility. In an embodiment, such server uses cloud computing for coupling to a webserver which stores part or all of the software and data of data storage device 38.

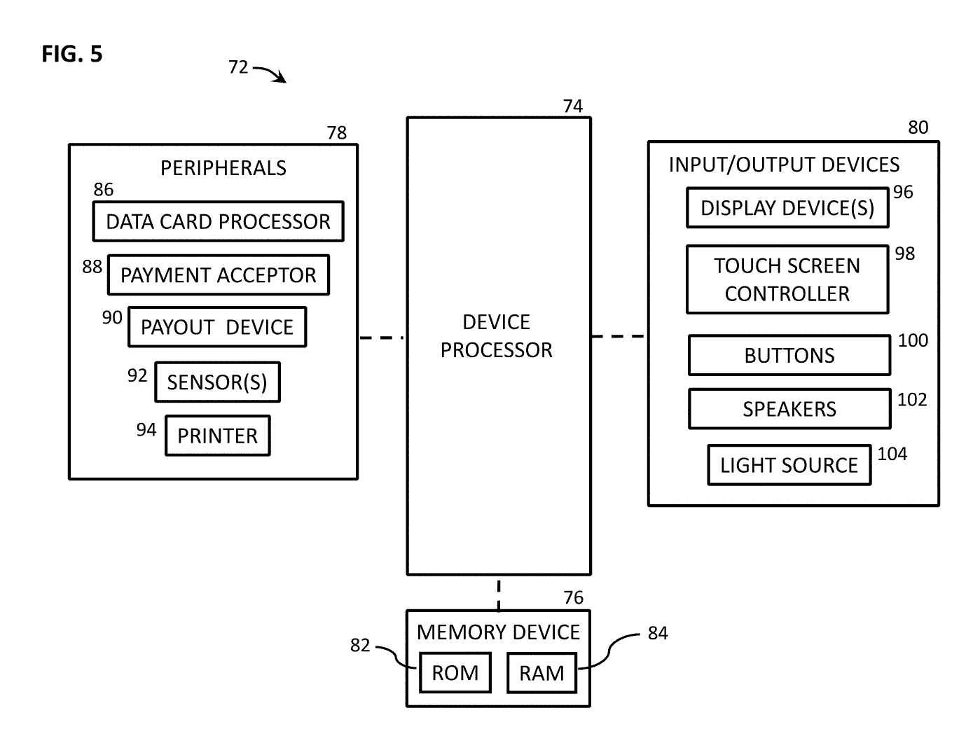

As illustrated in FIG. 5, in an embodiment, each device 26, 28, 30 has an electronic hardware configuration 72, which includes: (a) a central processing unit (CPU) or device processor 74; (b) a memory device 76 electronically coupled to the device processor 74; (c) a plurality of peripherals 78 electronically coupled to the device processor 74; and (d) a plurality of input/output (I/O) devices 80 electronically coupled to the device processor 74. The memory device 76 includes a Read-Only Memory (ROM) device 82 storing instructions executable by the device processor 74, and the memory device 76 includes a Random-Access Memory (RAM) device 84 storing data generated during play of the games 16, 20.

Depending upon the type of device 26, 28, 30, the peripherals 78 can include one or more or all of the following components or elements: (a) a data card reader or data card processor 86 configured to: (i) interface with a data card to read data (e.g., play credits) stored on the data card; and (ii) change or update the data on the data card, for example, by increasing play credits in response to a payout achieved by a player after a game ends; (b) a payment receiver, bill or coin validator or payment acceptor 88 configured to receive various forms of payments from players, such as player tracking player points awarded value though use of prepaid credit cards and/or credit cards, bills and coins; (c) a payout device 90 operable to output currency, bills, coins, tickets, slips, redeemable value to prepaid credit cards or credit cards or other items which have monetary value; (d) one or more detectors or sensors 92 operable to sense environmental conditions surrounding the device or operable to sense characteristics of the player or other items near the device; and (e) a printer 94 operable to print and dispense slips or tickets which have monetary value or play credits. In an embodiment, the sensors 92 include a biometric sensor, biometric reader (e.g., fingerprint reader or facial recognition device), sound sensor, microphone, speech recognition device, motion detector, temperature sensor or light sensor. In an embodiment, the data card processor 86 and the printer 94 each incorporate the payout device 90.

Depending upon the type of device 26, 28, 30, the I/O devices 80 can include one or more or all of the following components or elements: (a) one or more screens or display devices 96 operable to display the images, videos and graphics of the games 16, 20; (b) a touch screen controller 98 configured to: (i) detect or sense the screen locations where a player touches the display devices 96; and (ii) generate player inputs associated with the symbols or images at the locations of such touches; (c) a plurality of physical buttons 100 configured to generate different types of player inputs when the player touches or depresses the buttons 100; (d) a plurality of sound generators or speakers 102 operable to generate audio output, such as music and sound effects associated with the themes of the games 16, 20; and (e) at least one light source 104 operable to generate light to illuminate the area near the device, to attract attention when certain game events occur or to achieve other game-related purposes.

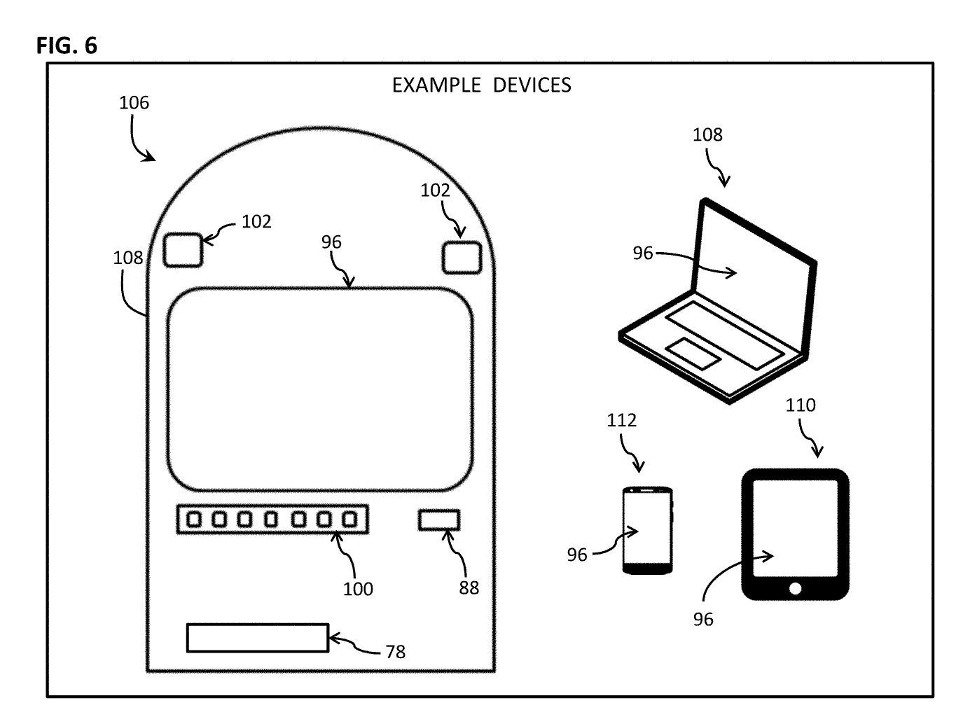

The gaming system 10 is operable with a plurality of different types of devices 26, 28, 30. In the examples shown in FIG. 6, each device 26, 28, 30 can include: (a) a Video Lottery Terminal, gaming machine, electronic wagering table or other gaming device 106; or (b) a laptop computer 108, tablet computer 110, smartphone 112 or other network access device. In an embodiment, the gaming device 106 includes a cabinet or housing 108 which houses or otherwise supports the device processor 74, memory device 76, peripherals 78 and I/O devices 80.

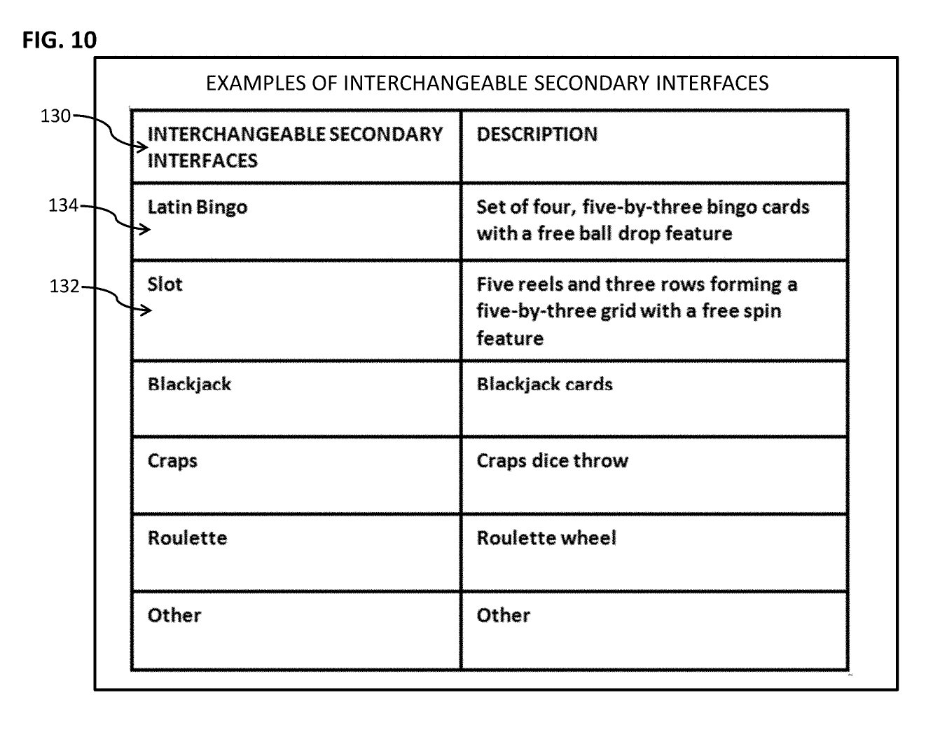

In an embodiment, the primary game 16 is a class II game according to the IGRA and NIGC, including, but not limited to, a bingo game, keno game, instant bingo game, scratch-off game, pull tab game, punch board game, lotto game, tip jar game, other games similar to bingo or card games. As described below, in an embodiment, the secondary game 20 has casino-style interfaces, such as slot interfaces 132, 166 described with respect to FIGS. 10 and 12-13. Despite such casino-style interfaces, the secondary game 20 is also a class II game according to the IGRA and NIGC. In an embodiment, the secondary game 20 has such class II status, in part, because: (a) the secondary game 20 includes or constitutes an electronic, computer or other technologic aid used in connection with bingo or another class II game, as permitted by the IGRA and NIGC; and (b) the secondary game 20 is based on a common draw-based secondary outcome generator 24 (not the RNG 54), as described below. In an embodiment, the secondary game 20 is not, and does not include, any games or slot machines excluded from the IGRA's definition of class III games.

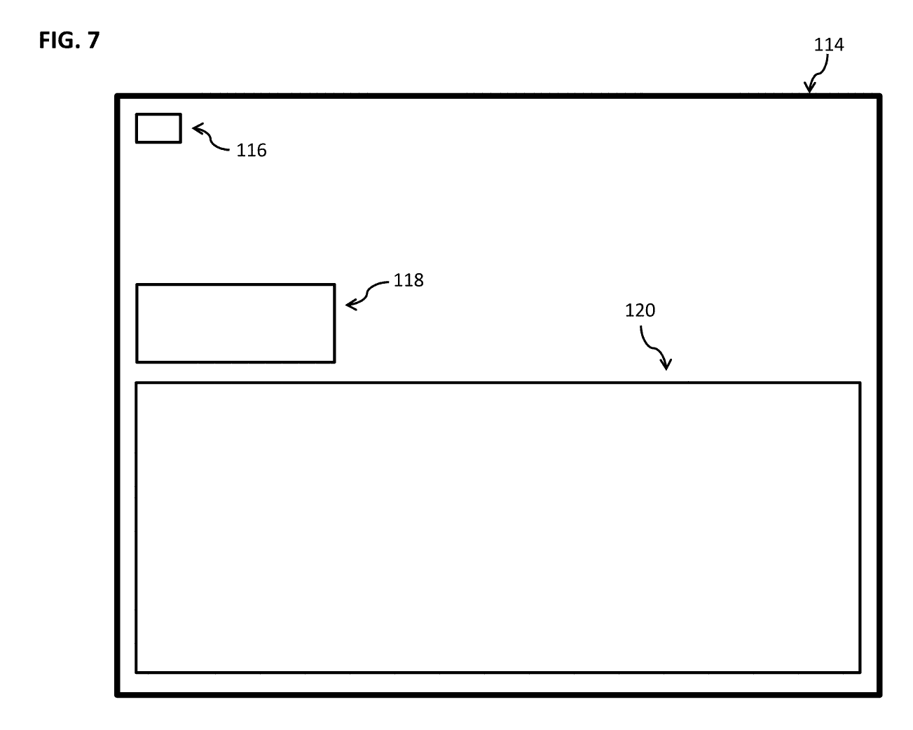

In a consolation embodiment, the secondary game 20 is a consolation game operable for players in consolation for non-winning, primary outcomes. In this consolation embodiment, the consolation game includes one or more consolation outcomes, such as consolation awards. The gaming system 10, in this embodiment, does not offer such consolation outcomes in the primary game 16. For example, the common primary outcome generator 22 does not include, and is disabled from generating, any consolation outcomes or consolation awards. Rather, only the common draw-based secondary outcome generator 24 includes, or is otherwise able to generate, the consolation outcomes and consolation awards. In operation, a player may receive a non-winning primary outcome based on the primary game 16, and the same player may receive a consolation award based on the secondary game 20. As illustrated in FIG. 7, the gaming system 10 displays a GUI structure or interface structure 114 including: (a) a primary window 116; (b) a reserve, inactive or parked secondary window 118; and (c) an active secondary window 120. In an embodiment, the parked secondary window 118 is larger than the primary window 116, and the active secondary window 120 is more than two times larger than the parked secondary window 118. In an embodiment, the gaming system 10 requires two or more players to compete against each other for an award or payout. In this embodiment, the primary and secondary games 16, 20 are multi-player, competition games.

In operation of one example, players 32 and 34 provide wager submissions (e.g., tickets, bills or coins or player tracking player points awarded value though use of prepaid credit cards and/or credit cards, or a data card) into devices 26 and 28, respectively. These wager submissions correspond to electronic wager signals or wager inputs which are generated by the devices 26, 28 and are receivable by the processor 40. Next, the gaming system 10 starts the gaming session 122 (FIG. 2) for the primary and secondary games 16, 20. In the embodiment in which the primary game 16 is a bingo game, the gaming system 10 starts the primary game 16 initially and then starts the secondary game 20 a fraction of a second later. In the embodiment in which the primary game 16 is a scratch-off game or other class II game, the gaming system 10 starts the primary game 16 and the secondary game 20 at the same time.

For each of the devices 26, 28, the gaming system 10 displays the primary game 16 within the primary window 116. In the embodiment in which the primary game 16 is a bingo game, the gaming system 10 displays a bingo card in the primary window 116 of device 26, and the gaming system 10 displays a different bingo card in the primary window 116 of device 28. Each such bingo card has a five-by-five grid with numbers displayed in the spaces of the grids. The two bingo cards have one or more differences in their numbers or the locations of their numbers on their grids.

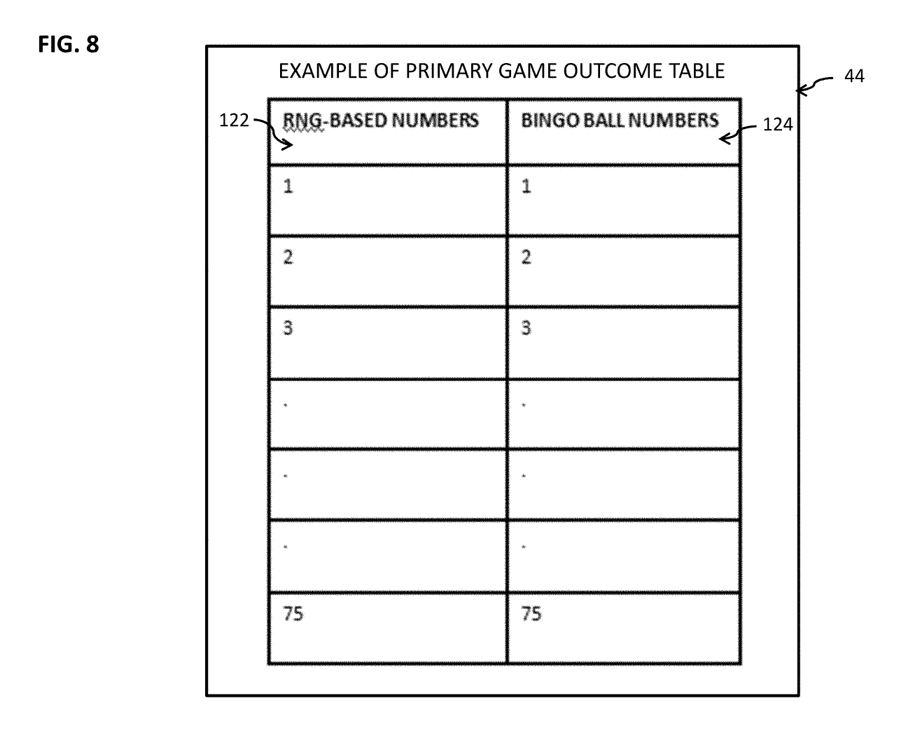

Next, as illustrated in FIG. 8, the gaming system 10 operates the RNG 54 to generate a sequence of numbers 122 corresponding to a sequence of numbered balls 124, such as a stream or sequence of seventy-five numbered balls. The primary window 116 of each of the devices 26, 28 displays a video of such balls dropping downward in one-by-one fashion. As the numbered balls match the numbers on the bingo cards, the gaming system 10 forms lines or patterns on the bingo cards. This bingo primary game 16 ends when a primary game-ending event occurs. In an embodiment, the primary game-ending event includes the earlier of: (a) the end of the ball-dropping process with non-winning primary outcomes by both players 32, 34; or (b) the occurrence of a winning primary outcome (e.g., progressive jackpot award) by either of the players 32, 34. In an embodiment, the gaming system 10 delays indicating these primary outcomes until the secondary outcomes are generated.

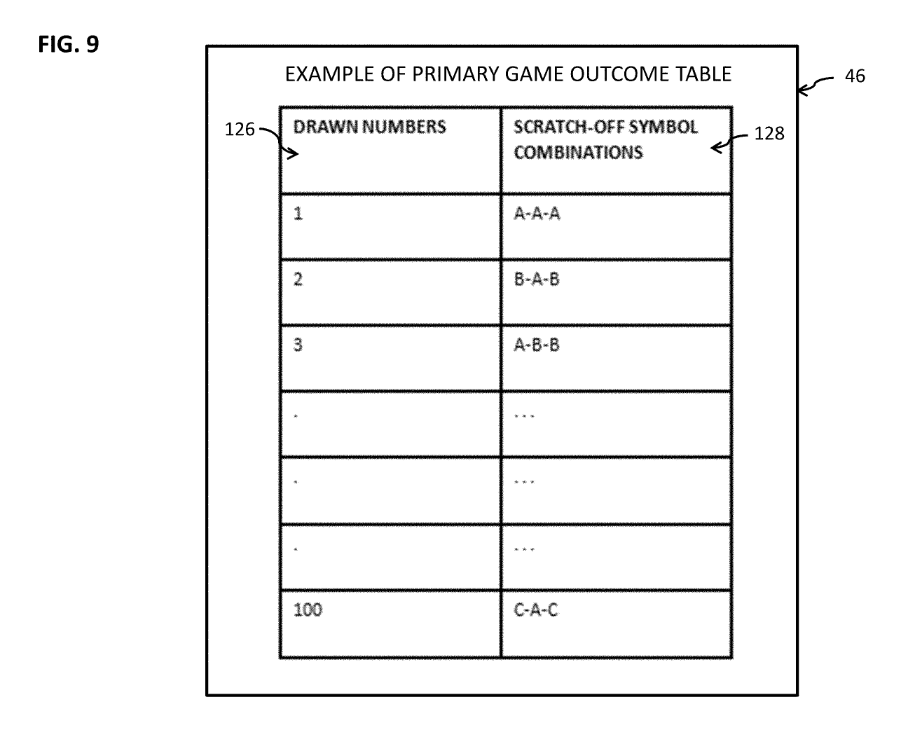

In the embodiment in which the primary game 16 is a scratch-off game, the gaming system 10 displays one or more scratch-off cards in the primary window 116 of device 26, and the gaming system 10 displays one or more different scratch-off cards in the primary window 116 of device 28. The scratch-off cards displayed by the devices 26, 28 have one or more differences in their symbols or the locations of their symbols on their grids. Next, as illustrated in FIG. 9, the gaming system 10 draws numbers from the finite primary outcome pool 52 (FIG. 2) to output a sequence of drawn numbers 126 corresponding to a plurality of scratch-off symbol combinations 128 revealed along each of the rows of the scratch-off cards. This scratch-off primary game 16 ends when a primary game-ending event occurs. In an embodiment, this primary game-ending event includes the earlier of: (a) the end of the scratch-off or symbol display process with non-winning primary outcomes by both players 32, 34; or (b) the occurrence of a winning primary outcome (e.g., progressive jackpot award) by either of the players 32, 34. In an embodiment, the gaming system 10 delays indicating these primary outcomes until the secondary outcomes are generated.

Upon or after the start of the primary game 16, the gaming system 10 operates the secondary game 20 as one or more consolation or additional win opportunities. In an embodiment, the gaming system 10 automatically starts the secondary game 20 without any prompts or input from the players 32, 34. As illustrated in FIG. 10, the gaming system 10 stores a plurality or group of different, interchangeable secondary interfaces 130. In an embodiment, the interchangeable secondary interfaces 130 are associated with different game types having different game themes.

As shown in the example in FIG. 10, the interchangeable secondary interfaces 130 can include a bingo interface or popular casino-style game interfaces, including, but not limited to: (a) a slot interface or simulation; (b) a blackjack interface or simulation; (c) a craps interface or simulation; (d) a roulette interface or simulation; (e) other casino-style game interfaces or simulations; or (f) other lottery interfaces or scratch-off game interfaces. In an embodiment described below, the interchangeable secondary interfaces 130 are not games. Rather, the interchangeable secondary interfaces 130 are skins or graphical representations of the underlying secondary game 20. In another embodiment, the interchangeable secondary interfaces 130 are associated with secondary phases of the secondary game 20.

The gaming system 10 enables the players 32, 34 to provide preference inputs for the interchangeable secondary interfaces 130. In this example, for each of the devices 32, 34, the gaming system 10 controls the display of the secondary interfaces 130 based on the preference inputs. For example, by default the gaming system 10 can display a slot interface 132 in the active secondary window 120 and can display a Latin bingo interface 134 in the parked secondary window 118. If either of the players 32, 34 provides a designated preference input, the gaming system 10 switches or swaps the locations of interfaces 132, 134. For example, after the swap, the gaming system 10 causes the applicable device 32 or 34 to display the Latin bingo interface 134 in the active secondary window 120 and to display the slot interface 132 in the parked secondary window 118. Based on this toggle or switching method, the gaming system 10 enables the players 32, 34 to increase their gaming interest and excitement by deciding which of the secondary interfaces 132, 134 to prominently display in the active secondary window 120. Also, this method enables implementors of the gaming system 10 to simulate a variety of selectable game types or game themes without having to reprogram the devices 26, 28.

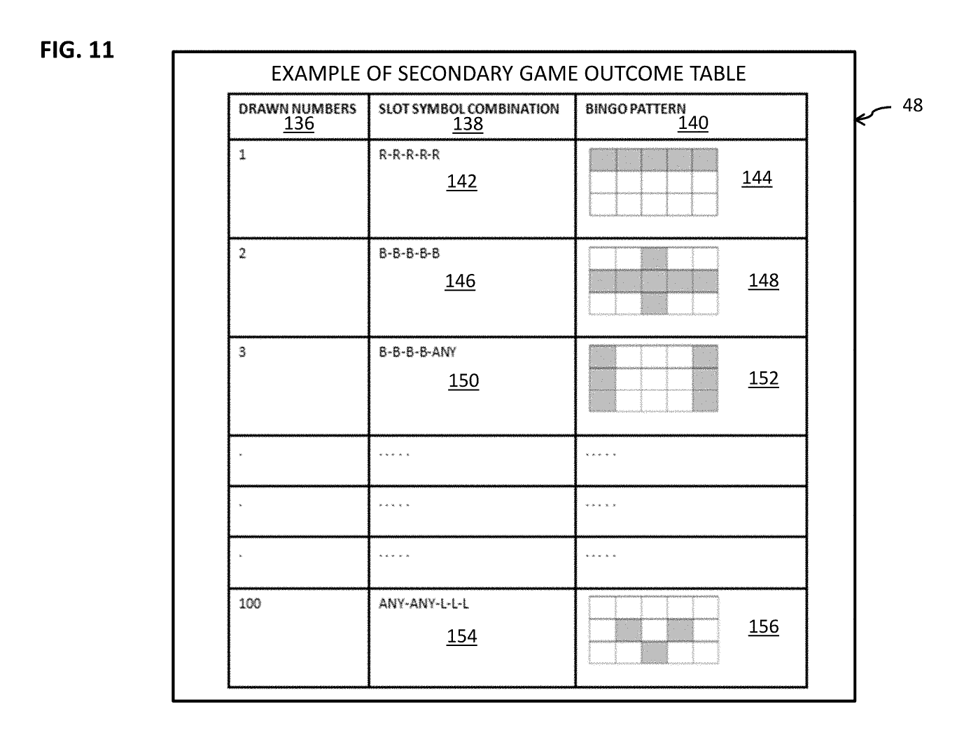

In an embodiment illustrated in FIG. 11, when the secondary game 20 starts, the gaming system 10 draws the numbers from the finite secondary outcome pool 60 to generate a sequence of numbers 136 corresponding to a plurality of slot symbol combinations 138 and bingo patterns 140. In an embodiment: (a) slot symbol combination 142 has the same outcome effect as bingo pattern 144; (b) slot symbol combination 146 has the same outcome effect as bingo pattern 148; (c) slot symbol combination 150 has the same outcome effect as bingo pattern 152; and (d) slot symbol combination 154 has the same outcome effect as bingo pattern 156.

For each of the devices 26, 28, the gaming system 10: (a) virtually rotates or spins the video reels of the slot interface 132 and stops the video reels to display the slot symbol combination 138 associated with the drawn number 136; (b) virtually drops a designated quantity (e.g., ninety) of bingo balls across the bingo cards or into the ball receiver of the Latin bingo interface 134 until all of such bingo balls have dropped; and (c) displays the bingo pattern 140 associated with the particular drawn number 136. In an embodiment, during the game session 122, the player can change between displaying the slot interface 132 in the active secondary window 120 or the Latin bingo interface 134 in the active secondary window 120 without suspending or interrupting the animation of the ball dropping (in the case of Latin bingo interface 134) or reel spinning (in the case of the slot interface 132).

In an embodiment, the gaming system 10 uses and exclusively applies the common draw-based secondary outcome generator 24 (not the RNG 54), including the finite secondary outcome pool 60, to determine all of the secondary outcomes for the secondary game 20. The gaming system 10 does so regardless of which ones of the secondary interfaces 130 are displayed to the players. In addition, as described above, the secondary game 20 is a competition game coupled to the common outcome pool 60 played by multiple players competing against each other. This operation of secondary game 20 contrasts with a class III game in which an individual player plays against an RNG of a class III gaming apparatus which generates outcomes independent of any other gaming apparatus. Because of these reasons and the elements of the gaming system 10, the secondary game 20 falls within the definition of class II according to the IGRA and applicable rules and regulations of the NIGC. Accordingly, in an embodiment, the entire gaming system 10 (including primary and secondary games 16, 20) and the devices 26, 28, 30 are qualified as class II games and class II gaming devices. It should be appreciated that such qualification can satisfy the legal requirements of countries and territories in addition to the United States, including, but not limited to, countries in western Europe, eastern Europe, Asia, Africa, Central America and South America.

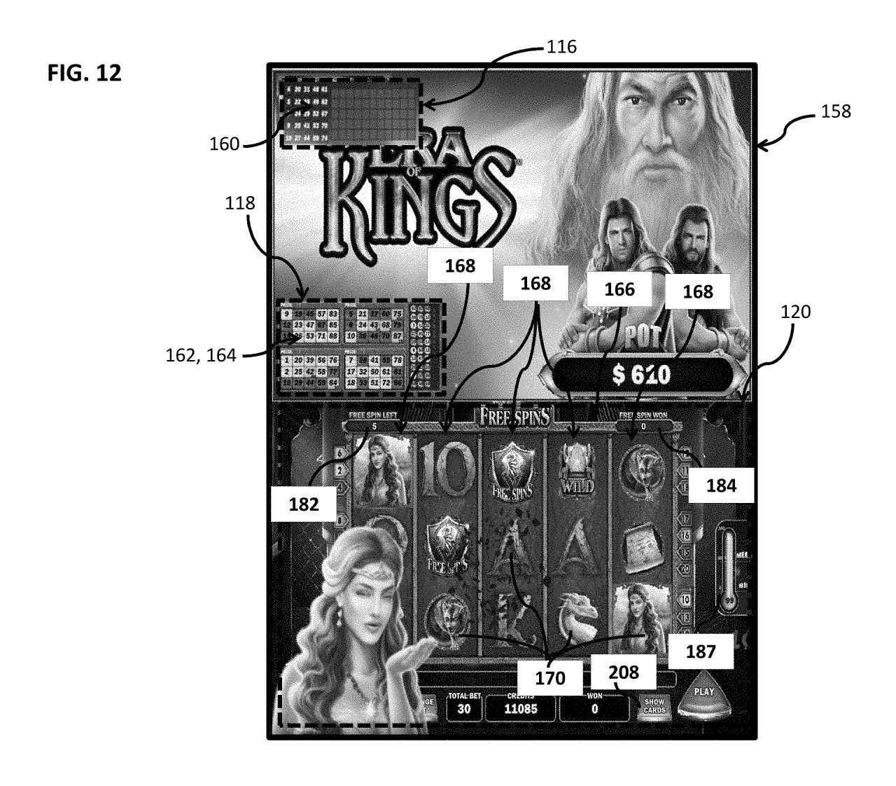

In an embodiment illustrated in FIG. 12, the gaming system 10 displays a main interface 158 at the beginning of the game session 122 (FIG. 2). The main interface 158 includes: (a) a classic bingo interface 160 within the primary window 116; (b) a Latin bingo image 162 of a Latin bingo interface 164 within the parked secondary window 118; and (c) a slot interface 166 within the active secondary window 120. The classic bingo interface 160 represents a classic bingo primary game 16 (FIG. 1). In this embodiment, the classic bingo interface 160 includes a card having a five-by-five grid (twenty-five spaces). As described above, the RNG 54 generates and graphically drops seventy-five balls numbered one through seventy-five in the classic bingo primary game 16. These balls drop across the cards of all of the players 32, 34, 36 (FIG. 1) who are simultaneously playing the classic bingo primary game 16 using different devices 26, 28, 30 (FIG. 1). In an embodiment, the classic bingo primary game 16 ends when all of the numbered balls drop for all of the players 32, 34, 36. The numbered balls form patterns on the players' cards to the extent that the balls' numbers match the numbers on the players' cards. If any of the players 32, 34, 36 achieve a winning outcome pattern, such as a five-space diagonal line, a five-space vertical line or a five-space horizontal line, the gaming system 10 allocates or designates a primary game outcome for such players 32, 34, 36. In an embodiment, one of the winning outcome patterns for a player of one of the devices 26, 28, 30 is associated with a progressive jackpot award. The progressive jackpot award is derived from historical wagers of previous players of such device 26, 28 or 30. As such, the progressive jackpot award is local or device-specific. As described below, in an embodiment, the gaming system 10 does not reveal or indicate the payout or award associated with any winning primary game outcomes until the completion of the secondary game 20.

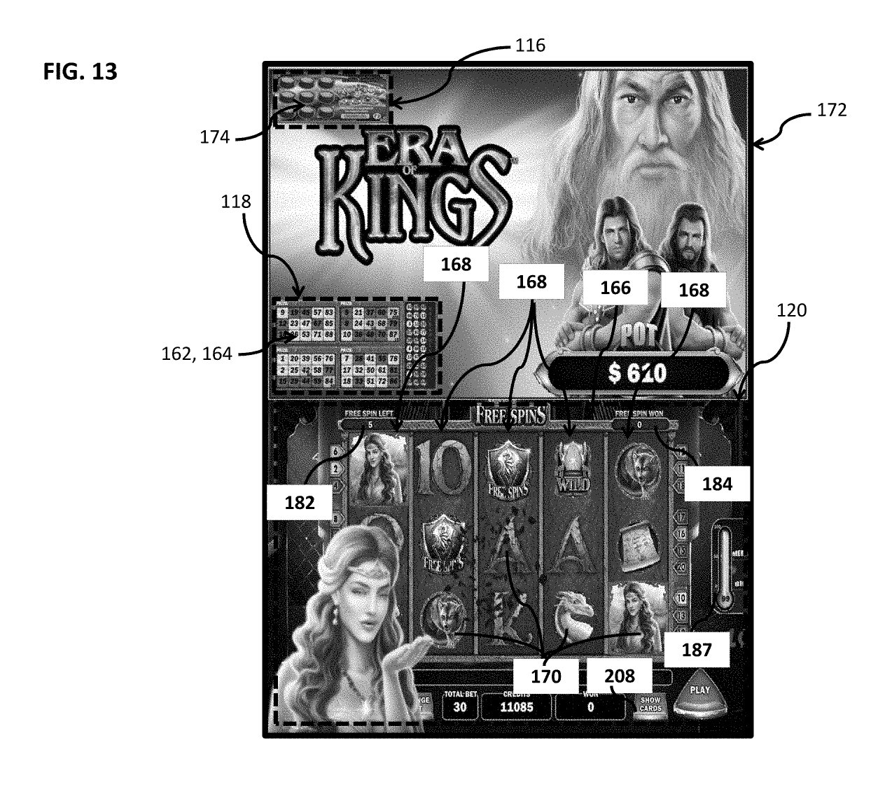

In an alternative embodiment shown in FIG. 13, the gaming system 10 displays a main interface 172 at the beginning of the game session 122 (FIG. 2). The main interface 172 has the same structure, functionality, logic and elements as main interface 158 except that the scratch-off game interface 174 is displayed within primary window 116 instead of the classic bingo interface 160. Depending upon the embodiment, the scratch-off game interface 174 can display one or more scratch-off cards. In this embodiment, the scratch-off game interface 174 represents a scratch-off primary game 16 (FIG. 1). To start such scratch-off primary game 16, the gaming system 10 draws a sequence of numbers from the finite primary outcome pool 56 (FIG. 2). The sequence of numbers corresponds to a plurality of symbol combinations revealed along each of the rows of the scratch-off game interface 174. If any of the players 32, 34, 36 achieves a winning symbol combination, such as a three-symbol string of A-A-A or B-A-B, the gaming system 10 allocates or designates a primary game outcome for such player 32, 34 or 36. In an embodiment, one of the winning outcome patterns is associated with a progressive jackpot award derived from historical wagers of previous players. As described below, in an embodiment, the gaming system 10 does not reveal or indicate the payout or award associated with any winning primary game outcomes until the completion of the secondary game 20.

For the embodiment having the bingo primary game and bingo interface 160 (FIG. 12), within a relatively short period of time after the start of such game, the gaming system 10 automatically starts the secondary game 20. Depending upon the embodiment, this period of time can be a fraction of a second or a suitable period within a range of one to five seconds. For the embodiment having the scratch-off primary game 16 and scratch-off game interface 174 (FIG. 13), the gaming system 10 automatically starts the secondary game 20 at the same time as starting such scratch-off primary game 16.

As described above, the gaming system 10 automatically runs the common draw-based secondary outcome generator 24 (FIG. 2) to initiate and operate the secondary game 20, such as a consolation game. For the graphics of the secondary game 20, the gaming system 10 initially, by default, displays the Latin bingo image 162 within the parked secondary window 118 and the slot interface 166 within the active secondary window 120. Alternatively, the gaming system 10 could initially, by default, display the slot interface 166 within the parked secondary window 118 and the Latin bingo image 162 within the active secondary window 120.

In the examples shown in FIGS. 12-13, however, the slot interface 166 is initially within the active secondary window 120, and the gaming system 10 automatically animates the video reels 168. The gaming system 10 causes the video reels 168 to simulate spinning motions in which the video reels 168 spin independent of each other. Each video reel 168 displays a strip of reel symbols 170. In an embodiment, the gaming system 10 designated twenty paylines or outcome lines extending across a plurality of the video reels 168. The outcome lines can be horizontal, vertical, diagonal or non-straight with one or more horizontal, vertical or diagonal segments. The gaming system 10 stops the video reels 168 so that they display the slot symbol combination 138 (FIG. 11) associated with the particular drawn number 136 (FIG. 11). Depending upon the embodiment and players' inputs, the players' wagers can be applied to one or more or all of such outcome lines.

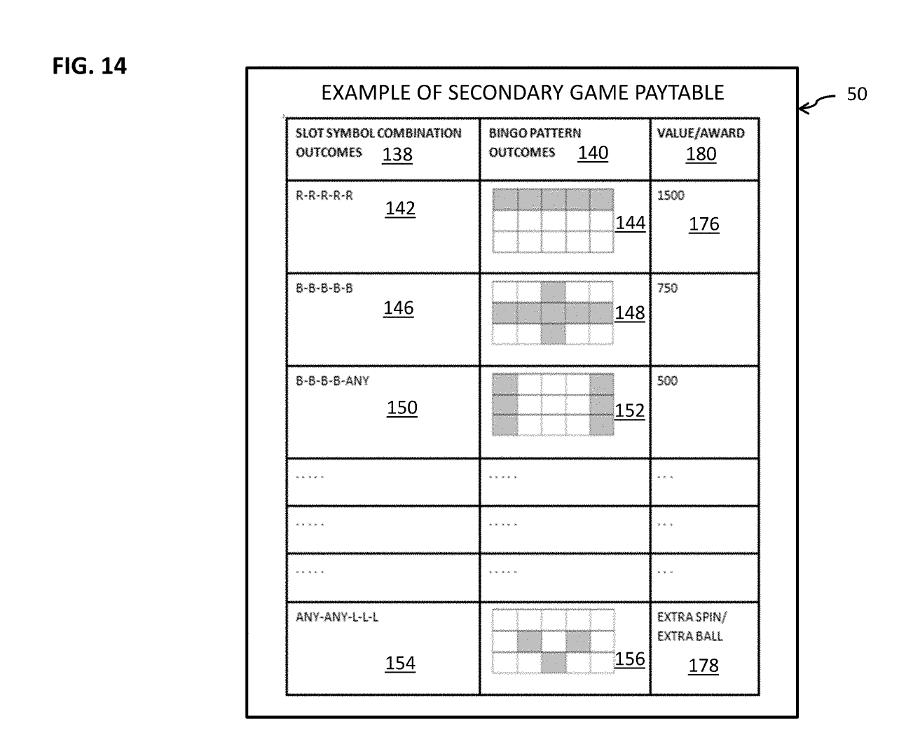

In an example shown in FIG. 11, if the number one is drawn, the stopped video reels 168 will display a horizontal combination 142 of five identical symbols or images of a ruler character, represented in FIGS. 11 and 14 as R-R-R-R-R. As illustrated in FIG. 14, in this example, the applicable player would achieve a secondary payout or value 176 of fifteen hundred credits if the player's wager were applied to the outcome line extending through such horizontal combination 142. In another example, if the number one hundred (FIG. 11) is drawn, the stopped video reels 168 will display a horizontal combination 154 of any two reel symbols and three identical symbols or images of a lion, represented in FIGS. 11 and 14 as ANY-ANY-L-L-L. As illustrated in FIG. 14, in this example, the player would achieve a secondary payout or award 178 of a free, extra spin of the video reels 168 if the player's wager were applied to the outcome line extending through such horizontal combination 154. This extra spin would provide a free chance to achieve a monetary secondary payout.

In an embodiment, the secondary game 20 includes a plurality of slot functions associated with the slot interface 166. The gaming system 10 uses the common draw-based secondary outcome generator 24 (not the RNG 54) to generate all of the outcomes of these slot functions for the players 32, 34, 36 who are simultaneously competing against each other in their play of the secondary game 20. These slot functions are described as follows:

(a) Extra Spin Function—One or more of the reel symbols 170 are associated with an extra spin award 178 (FIG. 14). If any of these reel symbols 170 are displayed to a player when the video reels 168 stop spinning, the gaming system 10 provides the player with a free opportunity to re-spin the video reels 168. Such re-spin provides the player with the chance to achieve a value or award 180 (FIG. 14). In an alternative embodiment of this free spin function, the gaming system 10 automatically provides each of the players 32, 34, 36 with a designated quantity of free spins at the beginning of the secondary game 20. In another embodiment, the gaming system 10 enables each of the players to input an addition wager to purchase one or more extra spins or re-spins of the video reels 168. Each such extra spin provides the applicable player with the chance to achieve a value or award 180 (FIG. 14).

(b) Free Spin Indication Functions—As illustrated in FIGS. 12 and 13, for each player, the gaming system 12 indicates: (i) the variable quantity of free spins remaining through the free spin balance indicator 182; and (ii) the variable quantity of free spins won or achieved through the free spins won indicator 184.

(c) Hold Function—When the video reels 168 stop spinning for each of the players 32, 34, 36, the gaming system 10 provides each such player with the opportunity to: (i) freeze, lock or hold a designated quantity of the video reels 168 or a designated quantity of the reel symbols 170, such as animated icons; and (ii) re-spin the non-held video reels 168 or re-spin all of the video reels 168 with the exception of the frozen or held reel symbols 170. Such re-spin provides each such player with the chance to achieve a value or award 180 (FIG. 14). This reel hold function may be useful and interesting to the player who receives two or more video reels 168 or reel symbols 170, for example, which bring him/her close to achieving a winning symbol combination 138 (FIGS. 11 and 14). Depending upon the embodiment, the gaming system 10 can provide this hold function for free or in response to an additional wager input (e.g., ante up) based on a wager submission from the applicable player.

(d) Lapse Function—In an embodiment, if a player receives the opportunity to use an extra spin or hold function, but the players fails to use such spin or function after a designated time period (e.g., 30 seconds), the gaming system 10 automatically cancels such extra spin and hold function. At this point, the player has forfeited such extra spin and hold function opportunities, and they are no longer available.

(e) Bet Change Function—The gaming system 20 enables each one of the players 32, 34, 36 to input a bet change for one or more of the paylines or outcome lines of the video reels 168. For example, if outcome line X has a bet or wager of one hundred credits and outcome line Y has no bet or wager, the player can move fifty credits from outcome line X to outcome line Y, causing outcome lines X and Y to each have a wager of fifty credits.

(f) Speed Control Function—The gaming system 10 enables each one of the players 32, 34, 36 to control the variable speed of the images, animations and outcomes of the secondary game 20. For example, a player can provide a speed input for selecting regular speed X or turbo speed Y. At regular speed X, the gaming system 10 can move or spin the video reels 168 at rate X. At turbo speed Y, the gaming system 10 can move or spin the video reels 168 at rate Y, a higher rate than rate X. In an embodiment, through this speed control function, each player can also control the rate of motion of the images, animations and outcomes in the bonus phases or bonus interfaces 188, 190 described below.

(g) Award Eligibility Meter Function—As illustrated in FIGS. 12-13, the main interfaces 158, 172 each include an award eligibility meter 187. Similar to a thermometer, the award eligibility meter 187 includes a scale which measures, for example, from zero to one hundred and includes: (a) a zero marker; (b) a fifty or midway marker associated with eligibility for a relatively big win; and (c) a one hundred marker associated with eligibility of a mega win larger than the big win. The lower bulb of the scale indicates the current readout of the meter 187. During the game session 122, the gaming system 10 tracks the speed or rate of play of all of the players 32, 34, 30 operating all of the devices 26, 28, 30. The rate of play can be derived from each player's input or wager activity within a designated period of time. For example, the rate of play can be based on how many game functions or features are used by each player within a six second time span. Based on the aggregated rate of play data for all players 32, 34, 30, the gaming system 10 determines the readout of the meter 187. In the example shown in FIG. 12, the readout is ninety-nine. Since ninety-nine is greater than the markers for the eligibility of the big win and mega win, the players 32, 34, 30 are all eligible for possibly winning the big win or mega win, and the gaming system 10 displays the number of players connected in the big win or mega win opportunities. The gaming system 10 determines whether and when to award a big win or mega win to a player based upon designated criteria stored in the system logic 12 (FIG. 1). In an embodiment, the gaming system 10 operates the common draw-based secondary outcome generator 24 (not the RNG 54) to determine and output the eligible big wins and mega wins.

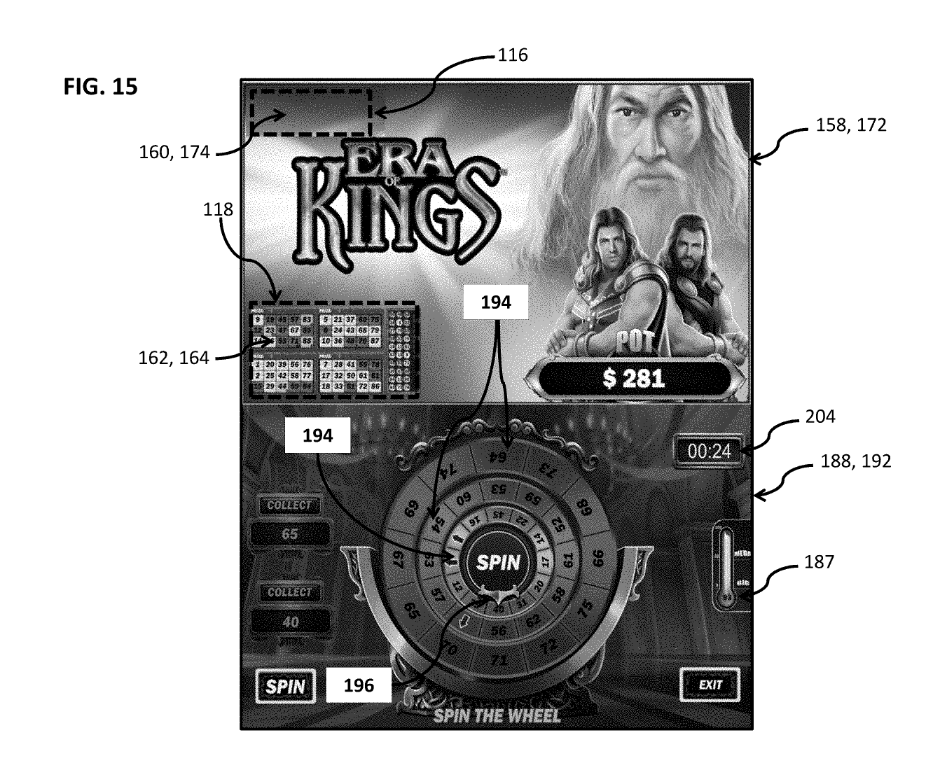

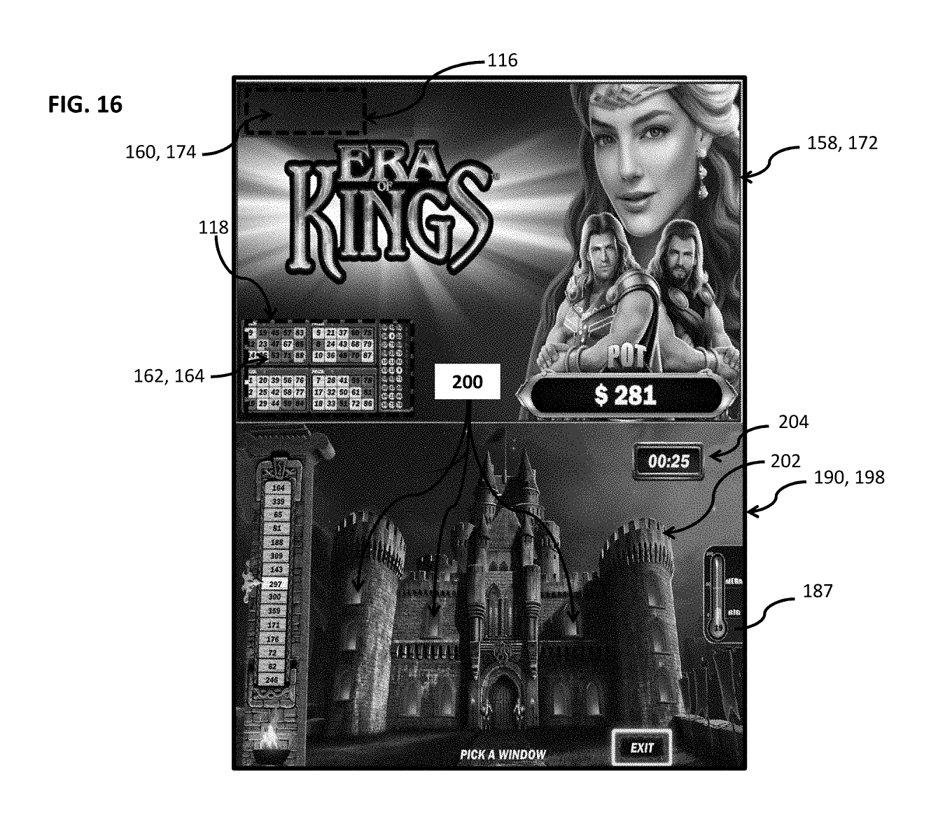

(h) Bonus Trigger Function—One or more of the reel symbols 170 are associated with a bonus triggering event corresponding to a bonus phase or bonus interface. If any of these reel symbols 170 are displayed to a player when the video reels 168 stop spinning, the gaming system 10 displays a bonus interface for such player, such as bonus interfaces 188, 190 (FIGS. 15-16). In an embodiment, the gaming system 10 operates the common draw-based secondary outcome generator 24 (not the RNG 54) to generate the bonus outcomes for the bonus phase or bonus interface. Other events can trigger the operation of the bonus phase or bonus interface. For example, the gaming system 10 can trigger its operation at different, predetermined times during the play of the secondary game 20.

In an embodiment illustrated in FIG. 15, bonus interface 188 includes a wheel interface 192. In this embodiment, the bonus interface 188 includes a plurality of concentrically-arranged disks or wheels 194. The wheels 194 are labeled with a string or chain of numbers corresponding to winnable bonus values. Depending upon the embodiment, one or more of the wheels 194 can spin independent of one or more of the other wheels 194. In operation, the applicable one of the players 32, 34, 36 provides a spin input. In response, the gaming system 10 spins the pointer 196. While the pointer 196 spins, the wheels 194 can remain still, or they can also spin as described above. When the spinning stops, the pointer 196 points at or indicates the bonus values of the wheels 194. The gaming system 10 allocates the indicated bonus values to the applicable player, and the gaming system 10 provides such indicated bonus values to the applicable player at the end of the game session 122.

In an embodiment illustrated in FIG. 16, bonus interface 190 includes a pick interface 198. In this embodiment, the bonus interface 190 includes a plurality of value masks or covers 200. One or more of the covers 200 conceal hidden bonus values of variable amounts, and some of the covers 200 can conceal no bonus values. In the embodiment shown, the covers 200 include darkened or opaque windows of a castle 202. In operation, the applicable one of the players 32, 34, 36 provides a pick or selection input, using his/her discretion to choose one of the covers 200. In response, the gaming system 10 reveals the bonus value (or lack thereof) behind the selected cover 200. The gaming system 10 allocates any revealed bonus value to the applicable player, and the gaming system 10 provides such revealed bonus value to the applicable player at the end of the game session 122. Depending upon the embodiment, the gaming system 10 can enable the player to make multiple selections of the covers 200 for multiple attempts to win hidden bonus values.

In an embodiment, the gaming system 10 includes timers or count-down clocks 204 and 206 associated with the bonus interfaces 188 and 190, respectively. Each clock 204, 206, starts at a certain time (e.g., thirty seconds) and continuously increments toward zero. With respect to bonus interface 188, if the applicable player does not provide a spin input before the clock 204 reaches zero, the gaming system 10 automatically spins the wheels 194 for such player. With respect to the bonus interface 190, if the applicable player does not provide a pick input before the clock 206 reaches zero, the gaming system 10 automatically picks one of the covers 200 for such player.

The bonus interfaces 188, 190 are examples of certain types of bonus interfaces. It should be appreciated that the secondary game 20 can trigger other types of bonus interfaces, including, but not limited to, games involving, races, chases, sports, contests or any suitable moveable or changeable image simulating an outcome generator which is activatable by one of the players 32, 34, 36.

Referring back to FIG. 11, in an embodiment, the gaming system 10 uses the same drawn numbers 136 (FIG. 11) to produce slot symbol combination outcomes 138 and bingo pattern outcomes 140. In this regard, the slot symbol combination outcomes 138 are mapped to the bingo pattern outcomes 140 as illustrated in FIG. 11. Also, each slot symbol combination outcome 138 is the mathematical or logical counterpart or equivalency of one of the bingo pattern outcomes 140. For example, slot symbol combination 142 is mathematically or logically equivalent to bingo pattern outcome 144, slot symbol combination 146 is mathematically or logically equivalent to bingo pattern outcome 148, slot symbol combination 150 is mathematically or logically equivalent to bingo pattern outcome 152 and slot symbol combination 154 is mathematically or logically equivalent to bingo pattern outcome 156. In an embodiment, once the secondary game 20 starts, the gaming system 10 operates and animates the Latin bingo interface 164 and the slot interface 166 at the same time based on the same drawn numbers 136 (FIG. 11).

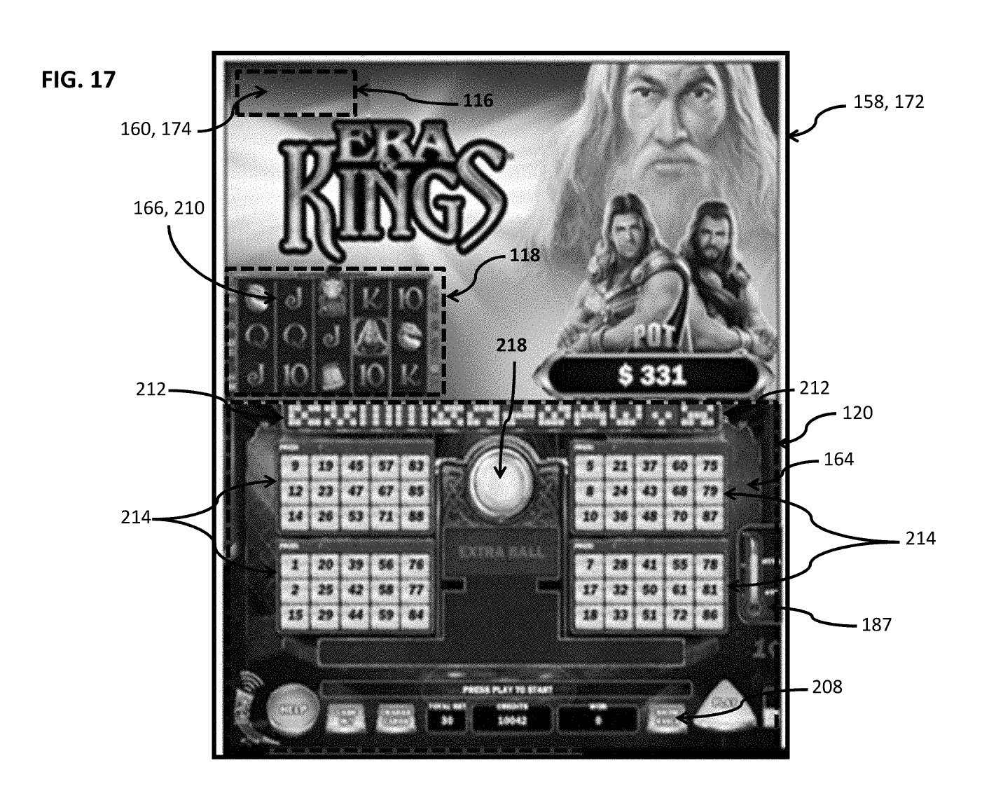

Depending upon the embodiment, the gaming system 10 can display image 162 (FIG. 12) or image 210 (FIG. 17) to cover the in-motion interface 164, 166 operating at the parked secondary window 118. Alternatively, the parked secondary window 118 can display the applicable active, in-motion interface 164 or 166 instead of statically displaying images 162, 210 of such interfaces. In such embodiment, the gaming system 10 displays both the Latin bingo interface 164 and the slot interface 166 in animated, active and operational states at the same time within the different windows 118, 120.

In an embodiment, after a player has exhausted all of the hold and re-spin function opportunities associated with the slot interface 166, the gaming system 10 displays an interface swap message. The interface swap message informs the player of the opportunity to provide a preference input, causing the secondary game 20 to: (a) display the Latin bingo interface 164 within the active secondary window 120; and (b) display an image 210 of the slot interface 166 within the parked secondary window 118. As described below, the player then has the opportunity to use the extra ball function associated with the Latin bingo interface 164.

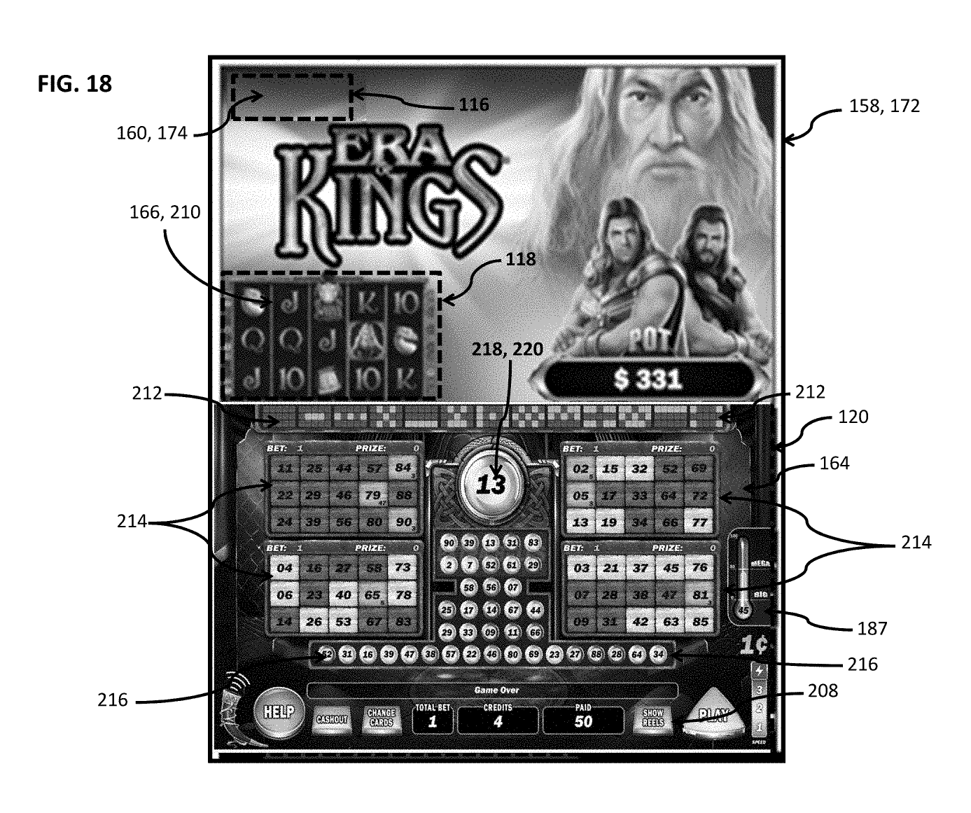

In an alternative embodiment, a player can provide a preference input if, at any time during the operation and animation of the slot interface 166 (FIGS. 12-13), the player wishes to swap the interchangeable interfaces 164 and 166. Depending upon the embodiment, the player can press the swap interfaces symbol 208 (FIGS. 12-13), or the player can touch the screen area of the parked secondary window 118. As illustrated in FIGS. 17-18, in response, the gaming system 10 performs the following steps: (a) displays the Latin bingo interface 164 within the active secondary window 120; and (b) displays an image 210 of the slot interface 166 within the parked secondary window 118.

In an embodiment, though the secondary game 20 has a starting point and ending point, the swapping between interchangeable interfaces 164 and 166 does not reset the secondary game 20 to its starting point. Rather, the secondary game 20 continues without being interrupted by the swapping. As illustrated in FIG. 17, the Latin bingo interface 164 has a starting state including: (a) a winning pattern indicator 212 displaying the various winning patterns for the player's four bingo cards 214; (b) an empty ball reservoir or ball collector 216 configured to receive and hold the bingo balls 216 (FIG. 18); and (c) an empty or blank extra ball indicator or holder 218 configured to display and hold an extra bingo ball 220 (FIG. 18). When the secondary game 20 starts, the gaming system 10 display an animation of a plurality of bingo balls (e.g., ninety bingo balls) sequentially dropping into and filling the ball collector 216 in one-by-one fashion until all of the balls have dropped, as illustrated in FIG. 18. Also, the gaming system 10 shades, colors or otherwise indicates the spaces on the bingo cards 214 which have numbers matching the dropped bingo balls 216. This indication forms outcome patterns which may or may not be winning outcome patterns.

In an embodiment, the secondary game 20 includes a plurality of Latin bingo functions associated with the Latin bingo interface 164. The gaming system 10 uses the common, finite, draw-based secondary outcome generator 24 (not the RNG 54) to generate all of the outcomes of these Latin bingo functions for the players 32, 34, 36 who are simultaneously competing against each other in their play of such secondary game 20. These Latin bingo functions are described as follows:

(a) Extra Ball Function—In an embodiment, the gaming system 10 includes a win proximity indicator. The win proximity indicator can be an audio indicator, visual indicator or audiovisual indicator. The gaming system 10 determines whether the future dropping of one or more balls bearing designated numbers will cause either one of the players 32, 34, 36 to achieve a winning outcome pattern. For example, the gaming system 10 can determine that the dropping of one or more bingo balls will cause either such player to achieve a winning outcome pattern. In such case, the win proximity indicator can output a visual or audio message, such as “YOU'RE ONE BALL AWAY FROM A BIG WIN!” In an embodiment, when either one of the players 32, 34, 36, reaches a designated proximity to receiving a winning pattern, such as one ball away, two balls way or three balls away, the gaming system 10 automatically provides such player with one or more extra balls without requiring an additional wager. In an alternative embodiment, the gaming system 10 requires such player to provide an additional wager to receive extra balls. In either such embodiment, either one of the players 32, 34, 36, can obtain an available extra ball by touching the extra ball image 218 illustrated in FIG. 17. In response, the gaming system 10 drops or displays an extra ball, such as extra ball 220 illustrated in FIG. 18. The extra ball 220, when applied to bingo cards 214, can cause such player to achieve one or more winning bingo patterns. In an embodiment, the extra ball opportunity associated with Latin bingo interface 164 is mathematically equivalent to the extra spin opportunity associated with slot interface 166 (FIG. 12).

(b) Extra Ball Indication Functions—In an embodiment, for each of the players 32, 34, 36, the gaming system 12 indicates: (i) the variable quantity of extra balls remaining through an extra ball balance indicator; and (ii) the variable quantity of extra balls won or achieved through an extra balls won indicator.

(c) Lapse Function—In an embodiment, if either one of the players 32, 34, 36 receives the opportunity to receive an extra ball, but such player fails to use such extra ball after a designated time period (e.g., 30 seconds), the gaming system 10 automatically cancels such extra ball. At this point, such player has forfeited such extra ball opportunity, and it is no longer available.

(d) Bet Change Function—The gaming system 20 enables each one of the players 32, 34, 36 to input a bet change for one or more of the bingo cards 214 displayed to each such player. For example, the applicable player can place bets on three of his/her bingo cards 214 but place no bet on the fourth bingo card 214. In another example, the applicable player can change the wager amounts for the different bingo cards 214.

(e) Speed Control Function—The gaming system 10 enables each one of the players 32, 34, 36 to control the variable speed of the images and outcomes of the secondary game 20 displayed on his/her device 26, 28 or 30. For example, one of the players 32, 34, 36 can provide a speed input for selecting regular speed X or turbo speed Y. At regular speed X, the gaming system 10 moves, rolls or drops the bingo balls 216 and indicates the applicable spaces of the bingo cards 214 at rate X. At turbo speed Y, the gaming system 10 moves, rolls or drops the bingo balls 216 and indicates the applicable spaces of the bingo cards 214 at rate Y, a higher rate than rate X.

(f) Award Eligibility Meter Function—As described above, the main interfaces 158, 172 each include the award eligibility meter 187 located within the Latin bingo interface 164.

(g) Bonus Trigger Function—In an embodiment, one or more of the bingo balls 216 or bingo pattern outcomes are associated with a bonus triggering event corresponding to one or more of the bonus phases or bonus interfaces described above, such as bonus interface 188 or 190 (FIGS. 15-16).

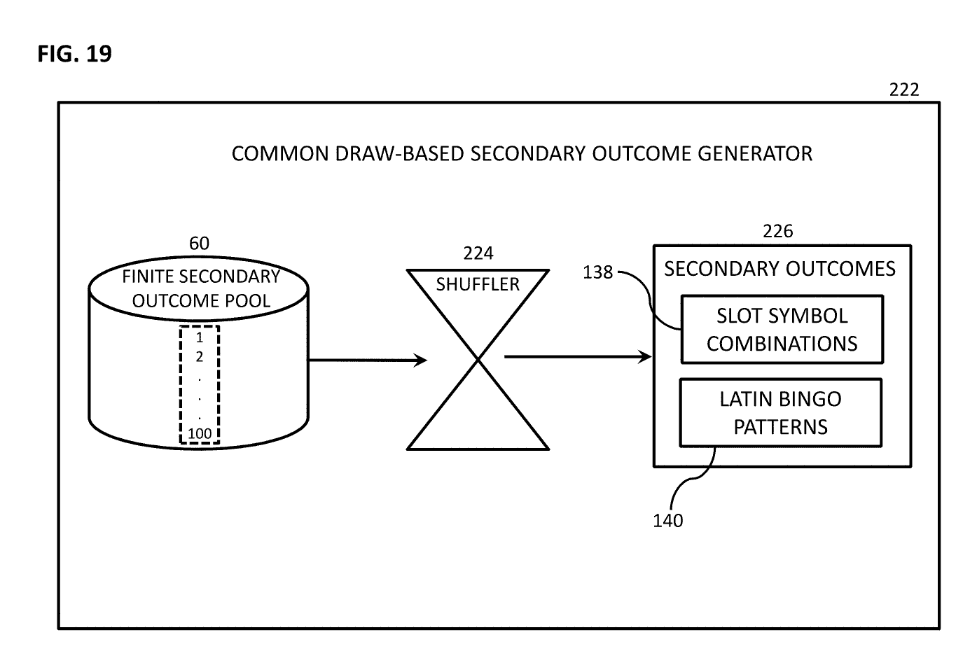

In an embodiment illustrated in FIG. 19, the common draw-based secondary outcome generator 222 includes a mixer, scrambler or shuffler 224 to provide post-processing of the numbers 136 (FIG. 11) drawn from the finite secondary outcome pool 60 (FIGS. 2 and 19). The shuffler 224 reduces the likelihood that the gaming system 10 will generate successive secondary outcomes 226 which are repetitive, redundant or predictable. Accordingly, the shuffler 224 improves the variability of the secondary game 20 to maintain game interest and reduce the likelihood that players will recognize or experience recurring secondary outcomes 226 in a single game session 122. In an embodiment, the shuffler 224 incorporates an RNG to facilitate the shuffling of the drawn numbers 136. In such embodiment, such RNG does not add numbers to the finite secondary outcome pool 60, does not remove numbers from the finite secondary outcome pool 60, does not modify the finite secondary outcome pool 60, and does not otherwise affect the drawing of numbers 136 from the finite secondary outcome pool 60. Rather, such RNG only mixes or shuffles the output of the finite secondary outcome pool 60. Accordingly, the use of such RNG does not disqualify the secondary game 20 from its class II regulatory status.

In an example of an embodiment, the gaming system 10 is operable according to the following method:

Step 228: Two players input their wagers into two devices.
Step 230: The gaming system starts a single game session operated for both of the players at the same time.
Step 232: The two players will compete against each other for one or more awards derived from one or more common outcome generators which are operatively coupled to both of the devices.
Step 234: At the beginning of the game session, the gaming system runs a class II primary game in accordance with the IGRA and NIGC, including, but not limited to, a classic bingo game based on an RNG or a scratch-off game based on a finite outcome pool. In this step 234, the gaming system displays miniature or relatively small primary game interfaces on the screens of both devices.
Step 236: The gaming system rapidly displays the primary outcomes on the screens of both devices.
Step 238: The primary game for both players terminates when a primary game-ending event occurs.
Step 240: If either player achieves a winning primary award, the gaming system reserves such award for such player and provides it to such player at the end of the game session.
Step 242: The gaming system automatically starts the secondary game. Depending upon the type of class II primary game, the gaming system performs this step concurrently with the start of the primary game or a fraction of a second thereafter.
Step 244: For the secondary game, the gaming system operates the common draw-based secondary outcome generator for both players. Such secondary outcome generator is based on one or more finite secondary outcome pools. Because of this and the logic and functionality of the secondary game described above, the secondary game qualifies as a class II game regardless of the graphical interfaces used to represent the secondary game, even if such graphical interfaces simulate or mimic class III games. In a consolation embodiment, the secondary game is a consolation game, and the secondary outcomes include one or more consolation prizes or awards generated based on one or more of finite secondary outcome pools described above. The gaming system 10 can make these consolation awards available to either player who has reached a non-winning, primary game-ending event, or the gaming system 10 can make these consolation awards available to either player who has received a relatively low value, winning primary award.
Step 246: The gaming system enables each of the players to select from a set of interchangeable interfaces, a desired interface for interacting with the secondary game. During the game session, each player can swap the interchangeable interfaces when designated events occur or when desired. In an embodiment in which the base or primary game is a scratch-off game, the gaming system enables a player to select or swap all three interchangeable interfaces when designated events occur.
Step 248: In the secondary game, each player has the opportunity to: (a) receive extra plays (e.g., reel spins or bingo balls), which can be free or require an additional wager; (b) freeze or hold desired slot reels or reel symbols for re-spins of an interchangeable slot interface; and (c) achieve a bonus triggering event, which triggers a bonus phase and the display of a bonus interface.
Step 250: If either player achieves a winning secondary award associated with the interchangeable interfaces or bonus interface, the gaming system reserves such award for such player and provides it to such player at the end of the game session.
Step 252: The secondary game for both players terminates when a secondary game-ending event occurs, such as the expiration of a designated period of time or the winning of a designated secondary award by either one of the players.
Step 254: After the secondary game-ending event occurs, the gaming system provides any awards or payouts achieved by the players. For example, the gaming system can cause each of the players' devices to: (a) dispense a ticket with redeemable, monetary credits; (b) dispense cash or currency; (c) update the data on the applicable player's data card with redeemable, monetary credits; or (d) add monetary credit to the applicable player's electronic, online financial account, digital prepaid credit card, or credit card.

It should be appreciated that in other embodiments, the gaming system 10 indicates award winnings and game outcomes throughout the game session 122 without waiting until the end of the game session 122. In such embodiments, the gaming system 10 can provide, deliver or output a payout or award credit at the end of the primary game 16 or anytime between the end of the primary game 16 and the end of the secondary game 20.

Though, in an embodiment, the primary and secondary games 16, 20 are class II games, it should be appreciated that the structure, logic and elements of the gaming system 10 (and games 16, 20) can be implemented in other classes or types of games, including, but not limited to, various wager-based or non-wager-based games operated or used in the United States, Asia, Eastern Europe, Western Europe, Africa, Central America, South America and other countries and territories of the world.

It should be appreciated that, in a consolation embodiment: (a) the supplemental or secondary game 20 described above is a consolation game including one or more consolation awards; (b) the finite number set 62 of the finite secondary outcome pool 60 (FIG. 2) corresponds to such consolation awards; and (c) the primary game 16 does not include, offer or make available such consolation awards. This consolation embodiment complies at least with the IGRA and NIGC.

The gaming system 10 provides a plurality of technical improvements, technical advantages and technical benefits over conventional, prior art gaming technologies. For example, such improvements, advantages and benefits include, but are not limited to:

(a) Efficient switching between isolated finite outcome pools and RNGs for efficiently switching between different types of primary games;

(b) Isolating a draw-based outcome generator from an RNG within a single system for securing the legally-regulated outcome generation process for secondary games;

(c) Structuring a single GUI template or layout to accommodate the user-friendly, simultaneous display of variable primary game interfaces and multiple, interchangeable primary game interfaces and/or multiple, interchangeable secondary game interfaces appearing in different locations on a single screen; and

(d) Decreasing the data processing time, loads and consumption by using a single draw-based outcome generator to output secondary outcomes mapped to, and used in connection with, a plurality of different interchangeable secondary game interfaces.

Referring back to FIG. 1, in an embodiment, the gaming system 10 can be stored in a master database, which incorporates the data storage device 38. As described above, the processor 40 can access such master database over any suitable type of network, or the processor 40 can access such master database directly if the master database and processor 40 are parts of a single server unit. In addition, network access devices operated by players and other users can access such master database over any suitable type of network. Depending upon the embodiment, the network can include one or more of the following: a wired network, a wireless network, a LAN, an extranet, an intranet, a WAN (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth® communication network, Cloud Computing network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

In an embodiment, the processor 40 can include a data processor or a CPU. The gaming system 10 can include one or more data storage devices, including, but not limited to, a hard drive with a spinning magnetic disk, a Solid-State Drive (SSD), a floppy disk, an optical disk (including, but not limited to, a CD or DVD), a RAM device, a ROM device (including, but not limited to, programmable read-only memory (PROM), electrically erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

Referring to FIG. 1, the players and other users (including, but not limited to, implementors of the gaming system 10) can use or operate any suitable input/output (I/O) device to transmit inputs to the gaming system 10 and to receive outputs from the gaming system 10, including, but not limited to, a personal computer (PC) (including, but not limited to, a desktop PC, a laptop or a tablet), smart television, Internet-enabled TV, person digital assistant, smartphone, cellular phone or mobile communication device. In one embodiment, such I/O device has at least one input device (including, but not limited to, a touchscreen, a keyboard, a microphone, a sound sensor or a speech recognition device) and at least one output device (including, but not limited to, a speaker, a display screen, digital signage display a monitor or an LCD).

In an embodiment, the computer-readable instructions, algorithms and logic of the gaming system 10 are implemented with any suitable programming or scripting language, including, but not limited to, C, C++, Java, COBOL, assembler, PERL, Visual Basic, SQL Stored Procedures, Extensible Markup Language (XML), Hadoop, “R,” json, mapreduce, python, IBM SPSS, IBM Watson Analytics, IBM Watson and Tradeoff Analytics. The gaming system 10 can be implemented with any suitable combination of data structures, objects, processes, routines or other programming elements.

In an embodiment, the interfaces of the gaming system 10 can be GUIs structured based on a suitable programming language. Each GUI can include, in an embodiment, multiple windows, pull-down menus, buttons, scroll bars, iconic images, wizards, the mouse symbol or pointer, and other suitable graphical elements. In an embodiment, the GUI incorporates multimedia, including, but not limited to, sound, voice, motion video and virtual reality interfaces to generate outputs of the gaming system 10.

In an embodiment, the memory devices and data storage devices described above can be non-transitory mediums that store or participate in providing instructions to a processor for execution. Such non-transitory mediums can take different forms, including, but not limited to, non-volatile media and volatile media. Non-volatile media can include, for example, optical or magnetic disks, flash drives, and any of the storage devices in any computer. Volatile media can include dynamic memory, such as main memory of a computer. Forms of non-transitory computer-readable media therefore include, for example, a floppy disk, flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution. In contrast with non-transitory mediums, transitory physical transmission media can include coaxial cables, copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during RF and IR data communications.

It should be appreciated that at least some of the subject matter disclosed herein includes or involves a plurality of steps or procedures. In an embodiment, some of the steps or procedures occur automatically as controlled by a processor or electrical controller. In another embodiment, some of the steps or procedures occur manually under the control of a human. In yet another embodiment, some of the steps or procedures occur semi-automatically as partially controlled by a processor or electrical controller and as partially controlled by a human.

As will be appreciated, aspects of the disclosed subject matter may be embodied as a system, method, or computer program product. Accordingly, aspects of the disclosed subject matter may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the disclosed subject matter may take the form of a computer program product embodied in one or more computer readable mediums having computer readable program code embodied thereon.

Aspects of the disclosed subject matter are described herein in terms of steps and functions with reference to flowchart illustrations and block diagrams of methods, apparatuses, systems and computer program products. It should be understood that each such step, function block of the flowchart illustrations and block diagrams, and combinations thereof, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create results and output for implementing the functions described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the functions described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions described herein.

Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. A gaming system comprising:
a data storage device storing a plurality of computer-readable instructions which are executable by at least one processor to:
receive a plurality of wager inputs from a plurality of devices, wherein the wager inputs correspond to a plurality of wagers from a plurality of players;
start a game session beginning with play of a primary game by a plurality of the players and continuing through each player's play of a secondary game;
in relation to the primary game:
cause each one of the devices to display a primary interface which graphically represents the primary game; and
determine a primary game outcome for each one of the players, wherein the primary game outcomes are selected from a common primary outcome pool;
in relation to each play of the secondary game, determine a secondary game outcome for each one of the players according to a secondary outcome generating process, wherein: (a) the secondary game outcomes are determined independent of the primary game outcomes; (b) the secondary game outcomes are selected from a common secondary outcome pool; and (c) the secondary game outcomes are eliminated from the common secondary outcome pool as the secondary game outcomes are selected;
receive a plurality of preference inputs from the devices, wherein each one of the preference inputs corresponds to one of the player's selection of a secondary interface from a group of secondary interfaces, wherein the secondary interfaces graphically represent different game types for the secondary game;
cause each one of the devices to operate the secondary game, wherein the operation comprises displaying one of the selected secondary interfaces and indicating one of the secondary game outcomes;
cause each one of the devices to indicate one of the primary game outcomes before, after or when the secondary game outcome is indicated by the device; and
depending upon the primary and secondary game outcomes, cause each one of the devices to provide at least one payout based on one of the wagers.

2. The gaming system of claim 1, wherein: (a) each device is operable by a different one of the players; (b) the devices are operatively coupled to at least one database which stores the common primary outcome pool and the common secondary outcome pool; and (c) the at least one processor is operable to at least partially control the plurality of devices.

3. The gaming system of claim 1, wherein the common primary outcome pool comprises at least one game-ending outcome, wherein the game-ending outcome comprises a win or a loss which ends the primary game for the players.

4. The gaming system of claim 3, wherein the primary game comprises a game selected from the group consisting of a bingo game, an instant bingo game, a pull-tab game, a scratch-off game, a punch board game, a tip jar game, game of cards, and a lottery game.

5. The gaming system of claim 3, wherein:
the primary game comprises a primary bingo game; and
the data storage device stores a plurality of computer-readable instructions which are executable by the at least one processor to:
cause each one of the devices to display a primary bingo interface which graphically represents the primary bingo game; and
determine the secondary game outcomes after the primary bingo game starts.

6. The gaming system of claim 3, wherein:
the primary games comprises a primary scratch-off game; and
the data storage device stores a plurality of computer-readable instructions which are executable by the at least one processor to:
cause the devices to display a primary scratch-off interface which graphically represents the primary scratch-off game, wherein the primary scratch-off interface displays one or more scratch-off cards for the primary scratch-off game; and
initiate determination of the secondary game outcomes upon initiation of the primary scratch-off game.

7. The gaming system of claim 1, wherein the data storage device stores a plurality of computer-readable instructions which are executable by the at least one processor to: (a) designate the selected secondary outcomes as eliminated from the common secondary outcome pool; and (b) maintain the designation until the game session ends.

8. The gaming system of claim 1, wherein the data storage device stores a plurality of computer-readable instructions which are executable by the at least one processor to cause each one of the devices to simultaneously display a plurality of selectable interface images associated with the group of secondary interfaces.

9. The gaming system of claim 8, wherein:
the group of secondary interfaces comprises a non-selected secondary interface; and
the data storage device stores a plurality of computer-readable instructions which are executable by the at least one processor to cause each one of the devices to simultaneously:
display the primary game within a primary game window comprising a first size;
display the interface image of the non-selected selected secondary interface within a parked interface window comprising a second size; and
display the operation of the selected secondary interface within an active interface window comprising a third size,
wherein the second size is greater than the first size, and the third size is greater than the second size.

10. The gaming system of claim 9, wherein the data storage device stores a plurality of computer-readable instructions which are executable by the at least one processor to: (a) receive an additional preference input from either one of the devices during the game session; and (b) based on the additional preference input, cause the device to change which one of the secondary interfaces is displayed within the active interface window.

11. The gaming system of claim 1, wherein the data storage device stores a plurality of computer-readable instructions which are executable by the at least one processor to: (a) receive a secondary wager input from either one of the devices, wherein the secondary wager input corresponds to a secondary wager from one of the players for the secondary game; (b) in response to the secondary wager input, determine an additional secondary game outcome according to the secondary outcome generating process; and (c) depending upon the additional secondary game outcome, cause the device to provide at least one payout based on the secondary wager.

12. The gaming system of claim 1, wherein the data storage device stores a plurality of computer-readable instructions which are executable by the at least one processor to: (a) receive a free play input from either one of the devices, wherein the free play input is associated with a free opportunity for a secondary game outcome for the secondary game; (b) in response to the free play input, determine an additional secondary game outcome according to the secondary outcome generating process; and (c) depending upon the additional secondary game outcome, cause the device to provide at least one payout based on one of the wagers.

13. The gaming system of claim 1, wherein:
each one of device comprises a device processor, a payment acceptor operatively coupled to the device processor, and a payout device operatively coupled to the device processor; and
wherein the data storage device stores a plurality of computer-readable instructions which are executable by the at least one processor to communicate with the device processors so as to cause each one of the payout devices to provide the at least one payout depending upon the primary and secondary game outcomes.

14. The gaming system of claim 1, wherein:
the secondary game comprises a consolation game;
the secondary game outcomes comprise a plurality of consolation game outcomes; and
the primary game outcomes exclude the consolation game outcomes.

15. A gaming system comprising:
a data storage device storing a plurality of computer-readable instructions which are executable by at least one processor to:
receive a plurality of wager inputs corresponding to a plurality of wagers from a plurality of players;
operate a primary outcome generator corresponding to a primary game comprising a primary interface, the operation of the primary outcome generator resulting in a plurality of primary outcomes for the plurality of players;
operate a supplemental outcome generator associated with a supplemental game, wherein:
the operation of the supplemental outcome generator comprises a plurality of outcome selection steps;
each one of the outcome selection steps results in a supplemental outcome selected from a finite pool of supplemental outcomes; and
each one of the supplemental outcomes selected in one of the selection steps is unavailable for all subsequent outcome selection steps;
access data corresponding to a plurality of supplemental interfaces comprising:
a first supplemental interface representing a first type of supplemental game; and
a second supplemental interface representing a second type of supplemental game;
in relation to each one of the players, receive a preference input corresponding to the player's selection of one of the first and second supplemental interfaces;
if the first supplemental interface is selected, cause the first supplemental interface to indicate at least one of the supplemental outcomes selected from the finite pool;
if the second supplemental interface is selected, cause the second supplemental interface to indicate at least one of the supplemental outcomes selected from the finite pool; and
indicate the at least one primary outcome before or after the indication of the at least one supplemental outcome.

16. The gaming system of claim 15, wherein the data storage device stores a plurality of computer-readable instructions which are executable by at least one processor to control a start process selected from the group consisting of: (a) starting the primary game and the supplemental game at a same time; and (b) starting the supplemental game after the primary game.

17. The gaming system of claim 15, wherein the primary outcome generator comprises a random number generator.

18. The gaming system of claim 15, wherein:
the finite pool related to the supplemental outcome generator comprises a supplemental finite pool; and
the primary outcome generator is configured to select a plurality of primary outcomes from a primary finite pool of primary outcomes,
wherein each one of the selected primary outcomes is unavailable for all subsequent selections from the primary finite pool.

19. The gaming system of claim 15, wherein the primary game satisfies legal requirements to qualify for a class II game type according to an Indian Gaming Regulatory Act of United States.

20. The gaming system of claim 19, wherein:
the supplemental game satisfies legal requirements to qualify for a class II game type according to an Indian Gaming Regulatory Act of United States; and
the supplemental game simulates a class III game type according to an Indian Gaming Regulatory Act of United States.

21. The gaming system of claim 15, wherein:
the supplemental game comprises a consolation game;
the supplemental outcomes comprise a plurality of consolation outcomes; and
the primary outcomes exclude the consolation outcomes.

22. A gaming device at least partially controlled by the at least one processor of claim 15, wherein:
the gaming device comprises a device processor, a payment acceptor operatively coupled to the device processor, a payout device operatively coupled to the device processor, and a display device operatively coupled to the device processor;
the payment acceptor is configured to receive a payment corresponding to one of the wager inputs; and
the data storage device stores a plurality of computer-readable instructions which are executable by the at least one processor to communicate with the device processor so as to cause the display device to display one of the first and second supplemental interfaces and so as to cause the payout device to provide at least one payout depending upon at least one of the supplemental outcome or at least one of the primary outcome.

23. A method for operating primary and secondary games, wherein the primary and secondary games qualify for a class II game type according to United States law, the method comprising:
receiving a plurality of wager inputs from a plurality of devices operated by a plurality of players;
controlling the primary game for the players, resulting in a game-ending primary game outcome;
controlling the secondary game for the players, resulting in a plurality of secondary game outcomes, wherein: (a) the secondary game outcomes comprise results of a plurality of selections from a finite pool of outcomes; and (b) the secondary game outcomes in the finite pool are selectable no more than once; and
causing each one of the devices to indicate a payout depending on the game-ending primary game outcome and at least one of the secondary game outcomes.

24. The method of claim 23, comprising storing interface data designated for each one of the devices, wherein the interface data corresponds to a group of interfaces configured to be displayed in each one of the secondary games, wherein the interfaces are different from each other.

25. The method of claim 24, wherein each one of the secondary game outcomes comprises a payout characteristic and a graphical characteristic, wherein the payout characteristics remain identical independent of which interface is displayed.

26. The method of claim 23, wherein:
the secondary game comprises a consolation game;
the secondary game outcomes comprise a plurality of consolation game outcomes; and
the primary game outcomes exclude the consolation game outcomes.

27. A gaming device comprising:
a housing;
a device processor positioned within the housing;
a payment acceptor operatively coupled to the device processor;
a payout device operatively coupled to the device processor; and
a display device operatively coupled to the device processor,
wherein the device processor is configured to communicate with at least one processor positioned within a data storage device located physically apart from the gaming device, wherein the data storage device stores a plurality of computer-readable instructions which are executable by the at least one processor to:
receive a plurality of wager inputs from the device processor and at least one additional device processor of an additional gaming device, wherein the wager inputs correspond to a plurality of wagers from a plurality of players;
start a game session beginning with play of a primary game by a plurality of the players and continuing through each player's play of a secondary game;
in relation to the primary game:
cause the gaming device and the additional gaming device to each display a primary interface which graphically represents the primary game; and
determine a primary game outcome for each one of the players, wherein the primary game outcomes are selected from a common primary outcome pool;
in relation to each play of the secondary game, determine a secondary game outcome for each one of the players according to a secondary outcome generating process, wherein: (a) the secondary game outcomes are determined independent of the primary game outcomes; (b) the secondary game outcomes are selected from a common secondary outcome pool; and (c) the secondary game outcomes are eliminated from the common secondary outcome pool as the secondary game outcomes are selected;
receive a plurality of preference inputs from the gaming device and the additional gaming device, wherein each one of the preference inputs corresponds to one of the player's selection of a secondary interface from a group of secondary interfaces, wherein the secondary interfaces graphically represent different game types for the secondary game;
cause the gaming device and the additional gaming device to each operate the secondary game, wherein the operation comprises displaying one of the selected secondary interfaces and indicating one of the secondary game outcomes;
cause the gaming device and the additional gaming device to each indicate one of the primary game outcomes before, after or when the secondary game outcome is indicated; and
depending upon the primary and secondary game outcomes, cause the payout device and the additional gaming device to each provide at least one payout based on one of the wagers.

28. The gaming device of claim 27, wherein:
the secondary game comprises a consolation game;
the secondary game outcomes comprise a plurality of consolation game outcomes; and
the primary game outcomes exclude the consolation game outcomes.
